(19) United States
(12) Patent Application Publication
(10) Pub. No.: US 2013/0161127 A1
(43) Pub. Date: Jun. 27, 2013

(54) ULTRA LIGHTWEIGHT SEGMENTED LADDER/BRIDGE SYSTEM ACCESSORIES

(71) Applicant: ALLRED & ASSOCIATES INC., Elbridge, NY (US)

(72) Inventors: Jimmie B. Allred, III, Skaneateles, NY (US); Joseph Kummer, Fayetteville, NY (US); Michael D. Griswold, Syracuse, NY (US); Michael J. Hall, Camillus, NY (US); Kyle Pilote, Marcellus, NY (US)

(73) Assignee: ALLRED & ASSOCIATES INC., Elbridge, NY (US)

(21) Appl. No.: 13/770,315

(22) Filed: Feb. 19, 2013

Related U.S. Application Data
(63) Continuation-in-part of application No. 13/104,375, filed on May 10, 2011.
Application No. 13/104,375 is a continuation-in-part of application No. 12/646,026, filed on Dec. 23, 2009.
(60) Provisional application No. 61/600,896, filed on Feb. 20, 2012.
(60) Provisional application No. 61/692,968, filed on Aug. 24, 2012.
(60) Provisional application No. 61/373,513, filed on Aug. 13, 2010.
(60) Provisional application No. 61/350,550, filed on Jun. 2, 2010.
(60) Provisional application No. 61/333,320, filed on May 11, 2010.
(60) Provisional application No. 61/151,327, filed on Feb. 10, 2009.
(60) Provisional application No. 61/141,402, filed on Dec. 30, 2008.

(51) Int. Cl. E06C 1/02; A61G 1/044

(52) U.S. Cl. CPC E06C 1/02; A61G 1/044
USPC 182/108; 182/115; 182/194; 5/626

(57) ABSTRACT

A dual-use ladder and bridge modular system preferably includes tubes, gussets, flanges, and/or joints. In a preferred embodiment, the tubes, gussets, flanges, and/or joints are made of carbon fiber. In one embodiment, a removable platform converts the segmented ladder system into a bus assault ladder/platform. Another preferred embodiment includes a bridge conversion kit. Yet another preferred embodiment includes a stretcher cover. When none of the bus assault platform, the bridge conversion kit, or the stretcher cover are needed, the ladder can be used as normal, or stored in a carry bag.

### REFERENCE TO RELATED APPLICATIONS

This application claims one or more inventions which were disclosed in Provisional Application No. 61/600,896, filed Feb. 20, 2012, entitled “SEGMENTED LADDER/STRETCHER SYSTEM” and Provisional Application No. 61/692,968, filed Aug. 24. 2012, entitled “ULTRA LIGHTWEIGHT SEGMENTED LADDER/BRIDGE SYSTEM ACCESSORIES”.

This is also a continuation-in-part application of co-pending application Ser. No. 13/104,375, filed May 10, 2011, entitled “ULTRA LIGHTWEIGHT SEGMENTED LADDER/BRIDGE SYSTEM”, which claims one or more inventions which were disclosed in Provisional Application No. 61/333,320, filed May 11, 2010, entitled “ULTRA LIGHTWEIGHT SEGMENTED LADDER/BRIDGE SYSTEM”, Provisional Application No. 61/350,550, filed Jun. 2, 2010, entitled “ULTRA LIGHTWEIGHT SEGMENTED LADDER/BRIDGE SYSTEM” and Provisional Application No. 61/373,513, filed Aug. 13, 2010, entitled “ULTRA LIGHTWEIGHT SEGMENTED LADDER/BRIDGE SYSTEM”, and a continuation-in-part application of co-pending application Ser. No. 12/646,026, filed Dec. 23, 2009, entitled “ULTRA LIGHTWEIGHT SEGMENTED LADDER/BRIDGE SYSTEM”, which claims one or more inventions which were disclosed in Provisional Application No. 61/141,402, filed Dec. 30, 2008, entitled “DUAL-USE MODULAR CARBON-FIBER LADDER AND BRIDGE” and Provisional Application No. 61/151,327, filed Feb. 10, 2009, entitled “ULTRA LIGHTWEIGHT SEGMENTED LADDER/BRIDGE SYSTEM”.

The benefit under 35 USC §119(e) of the United States provisional applications is hereby claimed, and the aforementioned applications are hereby incorporated herein by reference.

### BACKGROUND OF THE INVENTION

1. Field of the Invention

The invention pertains to the field of ladders and bridges. More particularly, the invention pertains to bus assault platform, bridge, and stretcher accessory conversion kits for a segmented carbon fiber ladder.

2. Description of Related Art

The use of ladders and small bridges is commonplace in commercial and military applications. Unfortunately, long ladders tend to be heavy and difficult to transport. In addition, units designed as ladders are not strong enough to be laid flat and used as a walking bridge or scaffolding. One solution to improve portability is to use a segmented ladder.

Segmented ladders are comprised of several smaller ladder sections, which are aligned and secured together to form a longer ladder at the time of use. The benefit of such a design is that, instead of transporting, for example, a single 20-foot long ladder, one can separately transport four five-foot sections, which are assembled only when needed. This allows ladders to be carried within cars, trucks, helicopters, and other vehicles with relative ease.

Several patents exist for segmented ladder designs. Leavitt and Whitehurst, U.S. Pat. No. 2,900,041, entitled “SECTIONAL LADDERS”, issued Aug. 18, 1959, discloses a simple, inexpensive sectional ladder that includes telescoping sleeve-type joints with a snap-action locking mechanism. Brookes et al., U.S. Pat. No. 3,995,714, entitled “MULTI-SECTION LADDER FOR SCALING POLES”, issued Dec. 7, 1976, discloses a multi-section ladder specifically for scaling poles. In this design, the main support rail runs along the center of the ladder, and the rungs are supported mid-span. Extending the work by Leavitt, U.S. Pat. No. 4,917,216, Kimber, entitled “SEGMENTED LADDER CONSTRUCTION”, issued Apr. 17, 1990, discloses a multi-step ladder construction unit with side rails, cross members joined at the ends, and telescopic ends for insertion into additional segments. A primary goal of this patent was to develop a system that was manufacturable at low cost.

Several segmented ladders are available commercially, including the Bauer Corporation Series 333 fiberglass parallel section ladder and Series 339 fiberglass tapered sectional ladder (Bauer Corporation, Wooster, Ohio), the S7900 series fiberglass sectional ladder from Werner Corporation (Werner Co., Greenville, Pa.), and the six-section surveyors ladder from Midland Ladder Co. Ltd (Birmingham, UK).

In addition to segmented ladders where the individual segments detach from one another, telescopic ladders are now widely available. One such example was disclosed by James and Richard Weston, U.S. Pat. No. 5,494,915, entitled “COLLAPSIBLE LADDER”, issued Mar. 5, 1996. In this patent, the entire ladder is comprised of individual sections that collapse and nest within one another for storage and transport. Although useful for certain applications, the entire ladder remains a single unit; hence the weight cannot be distributed amongst multiple separate units. In addition, this type of design does not work well for bridges, since the segments that are meant for use at the top of the ladder are inherently smaller and weaker than those intended for use at the bottom of the ladder. This configuration may be acceptable for a ladder, since the stresses while in use will typically be much less at the top than at the bottom; however, in a bridge or scaffold configuration, the segments must be equally rigid across the entire length for sufficient structural rigidity. Commercially available telescopic ladders include the Telesteps® telescoping ladder, the Up Up® ladder (Core Distribution, Inc., Minneapolis, Minn.), and the Xtend & Climb® ladder (Core Distribution, Inc., Minneapolis, Minn.).

Carbon fiber has been used in a limited basis for ladder fabrication. GMT Composites (Bristol, R.I.) offers a folding carbon-fiber ladder for use on boats. Cima Ladder (www.cimaladder.com, Spain) has produced a 1-piece carbon-fiber ladder for light duty use. Neither of these ladders is designed for easy disassembly into individual segments. There is a need in the art for a portable, lightweight segmented ladder that is also strong enough to utilize as a horizontal walking surface.

### SUMMARY OF THE INVENTION

A dual-use ladder and bridge modular system preferably includes tubes, gussets, flanges, and/or joints. In a preferred embodiment, the tubes, gussets, flanges, and/or joints are made of carbon fiber. A carbon fiber ladder segment includes a pair of tubular carbon fiber side rails, where each rail has a first end and a second end, at least one carbon fiber rung perpendicular to the carbon fiber side rails, where the carbon fiber rung connects the side rails of the ladder segment, and a joint connector located at at least one of the first end and the second end of each carbon fiber side rail. The joint connector on an end of a first carbon fiber side rail of a first ladder segment mates with the joint connector on a second carbon fiber side rail of a second ladder segment. When at least two ladder segments are joined by the joint connectors, they form a structure.

The present invention includes accessory conversion kits utilizing the carbon fiber ladders segments as the base component. In one embodiment, a removable platform converts the segmented ladder system into a bus assault ladder/platform. The removable bus assault platform includes a deck and tubes, which are preferably made of carbon fiber. The complete bus assault accessory kit includes the removable platform and two removable deck connectors.

In another embodiment, a c-channel reinforcement is added to the ladder side rails to reinforce the central region of the ladder, increasing the strength of the ladder when laid horizontally and used as a bridge. The c-channel reinforcements are preferably held in place by pins. In some preferred embodiments, the c-channel reinforcements also include an extended flange, offering a better walking surface.

In yet another embodiment, a stretcher cover is secured to the ladder rails and rungs. The stretcher cover turns the modular ladder into an emergency litter for wounded evacuation. The stretcher cover preferably includes straps for securing it to the ladder segments, as well as a second set of straps for securing a person to the stretcher.

### BRIEF DESCRIPTION OF THE DRAWINGS

FIG. 1 shows an assembled 6-rung version of a carbon-fiber ladder/bridge with gusset plate construction in an embodiment of the present invention.

FIG. 2 shows a close-up view of the gusset plate and rung construction shown in FIG. 1.

FIG. 3 shows the splice joint, rung, and flange construction of the ladder/bridge shown in FIG. 1.

FIG. 4 shows another embodiment of a ladder/bridge with a splice joint that includes a reinforcement plate and splice core.

FIG. 5 shows a close-up of the rung and side-rail assembly of the ladder/bridge of FIG. 4.

FIG. 6 shows a three-section ladder configuration with internal joint connectors and external reinforcement brackets in an embodiment of the present invention.

FIG. 7 shows the three-section configuration of FIG. 6 in a horizontal position for use as a bridge.

FIG. 8 shows a schematic of a carbon-fiber tube with embedded uni-directional and pultruded carbon fibers.

FIG. 9 shows a close-up schematic of a ladder design, including rungs, gussets and a joint.

FIG. 10 shows a joint location with a side beam removed to expose the internal connectors.

FIG. 11 shows a basic joint assembly with the side beams hidden.

FIG. 12 shows a female joint connection end of a ladder section.

FIG. 13 shows a male joint connection end of a ladder section.

FIG. 14 shows an internal joint connector with adhesive ridge gauges.

FIG. 15 shows a double pin assembly.

FIG. 16 shows the double pin assembly of FIG. 15 before insertion.

FIG. 17 shows a double pin assembly inserted into internal joint connectors.

FIG. 18 shows an alternative joint arrangement.

FIG. 19 shows the female joint connection of FIG. 18 with multiple flat plates.

FIG. 20 shows the male joint connection of FIG. 18 with multiple flat plates.

FIG. 21 shows a joint connection with multiple flat plate construction with the beams hidden.

FIG. 22 shows an individual male and female connector of the connection of FIG. 21 with multiple flat plate construction.

FIG. 23 shows another alternative joint connection.

FIG. 24 shows a female connection end of the joint connection shown in FIG. 23.

FIG. 25 shows a male connection end of the joint connection shown in FIG. 23.

FIG. 26 shows the internal joint connectors of the joint connection shown in FIG. 23 with the beams hidden.

FIG. 27 shows the internal joint connectors of FIG. 26 with the brackets and the front plates hidden.

FIG. 28 shows permanently mounted feet bonded into the terminal end of a ladder segment.

FIG. 29 shows an adjustable and removable ladder foot assembly.

FIG. 30 shows the adjustable and removable ladder foot assembly of FIG. 29 installed into the terminal end of a ladder segment.

FIG. 31 shows removable ladder hooks on the terminal end of a ladder segment.

FIG. 32 shows a step ladder angle connector.

FIG. 33 shows a four-section step ladder configuration including the angle connector shown in FIG. 32.

FIG. 34 shows a close-up view of the step-ladder connector joint shown in FIGS. 32 and 33.

FIG. 35 shows a 90 degree angle connector.

FIG. 36 shows a close-up view of the 90 degree angle connector shown in FIG. 35 with beams attached.

FIG. 37 shows an L-shaped structure made using a 90 degree connector and four ladder segments.

FIG. 38 shows a scaffold structure made using 90 degree connectors and six ladder segments.

FIG. 39 shows a ladder/bridge including a flat walking surface added to the horizontal ladder segments.

FIG. 40 shows another alternative joint connection.

FIG. 41 shows one side of the joint, where the mating portion of the internal joint connector on each beam is identical.

FIG. 42 shows the internal joint connector with the beam hidden.

FIG. 43 shows two internal joint connectors mated together with the beams hidden.

FIG. 44 shows two internal joint connectors connected using plates and pins.

FIG. 45 shows an individual sleeved ladder section.

FIG. 46 shows the ladder section of FIG. 45 with one of the side beams hidden.

FIG. 47 shows a single rung with two ring flanges.

FIG. 48 shows a rung construction method utilizing pultruded and braided carbon fiber.

FIG. 49 shows another embodiment of a segmented ladder.

FIG. 50 shows another embodiment of a segmented ladder.

FIG. 51 shows an alternative embodiment of a connector.

FIG. 52 shows the connector of FIG. 51 connecting two ladder segments.

FIG. 53 shows another embodiment of a connector.

FIG. 54 shows the connector of FIG. 53 being used to create a structure with both vertical and horizontal members.

FIG. 55 shows another embodiment of a connector.

FIG. 56 shows the connector of FIG. 55 being used to create structures with horizontal and angled members.

FIG. 57 shows another embodiment of a segmented ladder that allows complete disassembly and compact storage of the components.

FIG. 58 shows an exploded view of the ladder of FIG. 57.

FIG. 59 shows an embodiment of a storage arrangement for the ladder segment components of FIGS. 57 and 58.

FIG. 60 shows a removable deck in an embodiment of the present invention.

FIG. 61 shows a removable deck connector in an embodiment of the present invention.

FIG. 62 shows the removable deck of FIG. 60 and the removable deck connector of FIG. 61 attached to a ladder segment, creating a bus assault platform.

FIG. 63 shows the bus assault platform of FIG. 62 with an additional ladder segment added.

FIG. 64 shows a bridge conversion kit attached to a segmented ladder, creating a segmented bridge.

FIG. 65 shows a top view of the segmented bridge of FIG. 64.

FIG. 66 shows a close-up view of the segmented bridge conversion kit of FIG. 64.

FIG. 67 shows another embodiment of the segmented bridge, including a walking platform.

FIG. 68 shows another embodiment of the segmented bridge, including four pieces.

FIG. 69 shows the segmented bridge of FIG. 68, with two bridge pieces hidden, showing the splices.

FIG. 70 shows a top perspective view of a stretcher cover accessory in an embodiment of the present invention.

FIG. 71 shows an individual strapped to the stretcher cover accessory of FIG. 70.

FIG. 72 shows a bottom perspective view of the stretcher cover accessory of FIG. 70.

### DETAILED DESCRIPTION OF THE INVENTION

Carbon-fiber (CF) tubes and gusset plates can be used to create various structures, including trusses, bridges, supports for equipment, and many others. By fabricating a segmented ladder from carbon-fiber composites and metal or composite joints, the result is a unit that is both portable, as well as strong enough to utilize as a horizontal walking surface. The present invention includes a dual-use ladder and bridge structure preferably composed of carbon-fiber tubes, gussets, flanges, and/or joints. In particular, this design lends itself well to a segmented carbon-fiber ladder and bridge, but could be used for other designs as well. Within the framework of the design, the joint connectors (or splices) are an important component.

The present invention also includes a method for joining carbon-fiber tubes that is applicable where one needs the ability to both connect, as well as disconnect, the tubes. Another method creates a lightweight carbon-fiber beam with exceptionally high stiffness and strength using a combination of carbon-fiber braid material, uni-directional cloth, and pultruded carbon-fiber strips.

The structure includes modular construction of multiple pieces that are assembled into one or more ladders, bridges or other structures at the time of use, and then disassembled for storage or travel when the obstacle is cleared. The obstacles could include both vertical obstacles and horizontal obstacles. Some vertical obstacles include, but are not limited to, walls, trees, and rocks. Some horizontal obstacles include, but are not limited to, moving from rooftop to rooftop, moving from window to window, or crossing a river.

In a preferred embodiment, the carbon-fiber structures of the present invention are composed of a combination of carbon fiber tubes, carbon fiber gussets, carbon fiber flanges, and/or carbon fiber splices. Some uses for this carbon fiber assembly include a climbing ladder, when an individual needs to scale an obstacle vertically, and a bridge, when an individual needs to cross an obstacle horizontally.

The modular devices of the present invention, which preferably include multiple identical segments, can be built and used as a ladder, a bridge, or any other segmented structure, including, but not limited to, a scaffold or truss structure. While the structure preferably includes pieces made of carbon fiber, the modular ladder/bridge system of the present invention could alternatively be manufactured out of other lightweight materials, such as fiberglass, aluminum, or titanium, or any combination of these and other materials. The obstacles could include both vertical obstacles and horizontal obstacles. A ladder, as defined herein, is a structure that includes steps which include two parallel members connected by rungs. A bridge, as defined herein, is any structure that spans and provides passage over a gap, barrier, or other obstacle, thus allowing people, animals, vehicles or other objects to bypass the obstacle. These two terms will be used interchangeably herein.

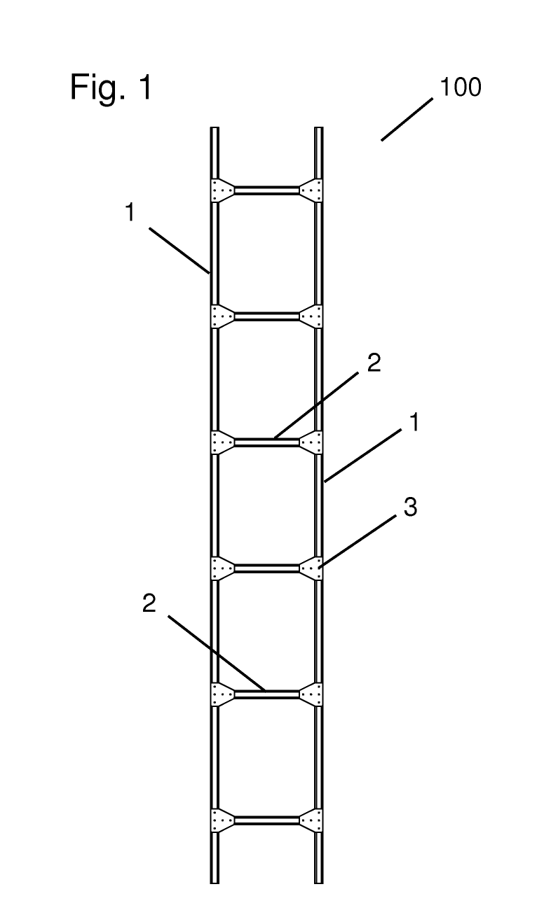

An embodiment of the present invention is shown in FIG. 1, which depicts an assembled segmented ladder/bridge structure 100. The ladder/bridge 100 includes main support beams, which are preferably tubes 1, and perpendicular rungs 2 that act as hand and foot supports. The main support tubes are permanently connected to the rungs 2. In a preferred embodiment, the main support tubes 1 and the perpendicular rungs 2 are made of carbon fiber. The rungs are preferably permanently connected by bonding them with an adhesive to the side support tubes with gussets 3. Bonding, as used herein, is the use of an adhesive layer placed at the mating surfaces between two components that results in a permanent connection. In a preferred embodiment, the gussets 3 are made of carbon fiber. A precision fixture is used to hold the assembly in the correct position during fabrication while the adhesive cures.

FIG. 1 shows a six-rung version of the structure 100. However, a structure 100 with any alternative number of rungs 2 and segments could be manufactured, depending upon the intended use of the structure 100. The rungs 2 are preferably evenly spaced when the structure 100 is assembled.

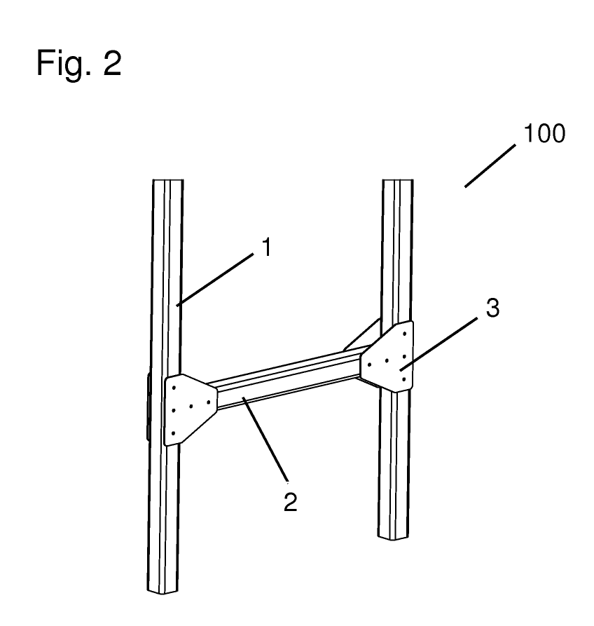

FIG. 2 shows a close-up view of an example of carbon fiber gusset plate construction. In this example, 1-inch square carbon fiber tubes are used for both the tubes 1 and the rungs 2 in the entire structure. However, other sizes for the carbon fiber tubes, including, but not limited to, 0.75 inch square and 2 inch square, as well as other shapes for the carbon fiber tubes, including, but not limited to, carbon fiber tubes that are round, rectangular, or rectangular with rounded ends, in cross-section, could alternatively be used. In addition, the carbon fiber tubes may be braided carbon fiber tubes. Preferred materials in the embodiments where carbon fiber tubes are used in the ladder/bridge are DragonPlate™ Engineered Carbon Fiber Composites (Allred & Associates Inc., Elbridge, N.Y.). In other embodiments, the segments of the ladder in the modular system may be made of other lightweight materials, or a combination of materials.

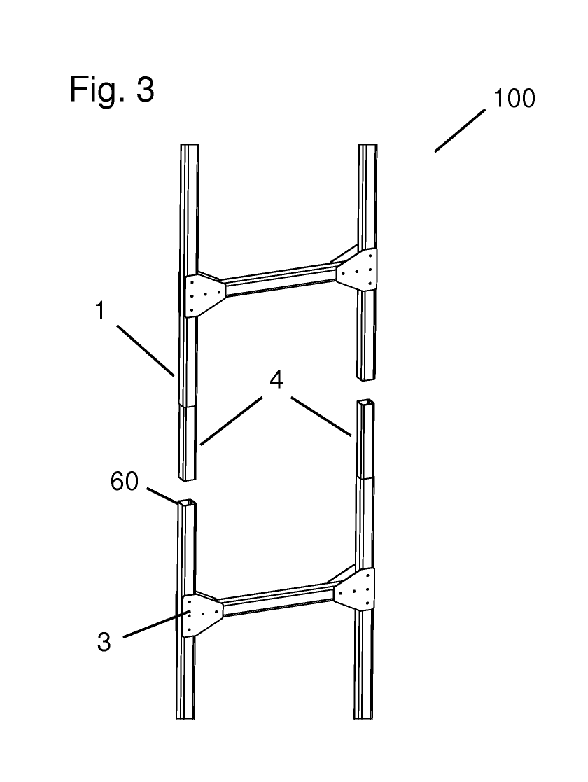

FIG. 3 shows the ladder/bridge 100 pulled apart, to show splice joint, rung, and flange construction of the ladder/bridge 100. Splice connections 4 are shown in FIG. 3. The splices 4 slide into sleeves 60 formed by the outer tubes 1 and are bonded into place. In this case, a splice 4 is bonded approximately half-way into one of the support tubes. Opposite splices 4 are lined up with the mating tubes 1 and pressed together at the time of use. A pin, clip, or other fastener can optionally be used to guarantee the splice 4 does not come apart during use.

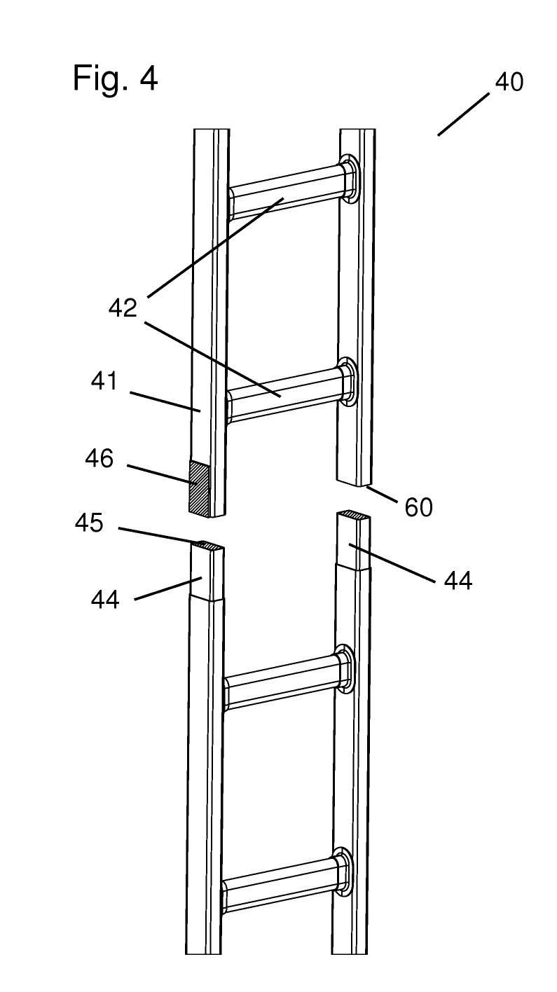

Often, added structural stiffness is necessary, for example for greater weight loads or if the ladder is longer. FIG. 4 shows an alternative construction for the structure 40, which is preferably constructed as a ladder or a bridge. In this figure, instead of the square side supports 1, the tubes 41 are now preferably rectangular. By doing this, the stiffness of the main supports is greatly increased without substantially increasing the weight. In a preferred embodiment, the tubes 41 are carbon fiber tubes. In embodiments where carbon fiber tubes are used, any usable size for the carbon fiber tubes 41 (as well as the rungs 42), including, but not limited to, 0.75 inch square, 1 inch square, and 2 inch square, as well as other shapes for the carbon fiber tubes, including, but not limited to, carbon fiber tubes that are square, round, or rectangular with rounded ends, in cross-section, could alternatively be used. In addition, the carbon fiber tubes may be braided carbon fiber tubes. Preferred materials for the carbon fiber tubes and other components of the ladder/bridge are DragonPlate™ Engineered Carbon Fiber Composites (Allred & Associates Inc., Elbridge, N.Y.).

In addition, a core material 45, typically foam, is preferably added inside the splice joint 44 to increase rigidity and damage tolerance. The core 45 could alternatively be made of any lightweight material able to increase the structural stiffness of the ladder/bridge 40, including, but not limited to, a lightweight wood, for example balsa wood. The core material 45 may also optionally be included in the tubes 41, and/or the rungs 42, to further increase stability.

FIG. 4 also shows the rungs 42, which are preferably a rectangular shape with rounded ends, although they could alternatively be other shapes including, but not limited to, square, round, or rectangular. Reinforcement plates 46 may optionally be added on the side beams 41 on the side opposite the internal splice 44 for additional strength. Note that the core material 45 and/or the reinforcement plates 46 may alternatively be included in the ladder/bridge 100 shown in FIGS. 1-3. For example, the core material 45 may be incorporated inside any or all of the main support tubes 1, the rungs 2, and or the splice connections 4 of the ladder/bridge 100 shown in FIGS. 1-3.

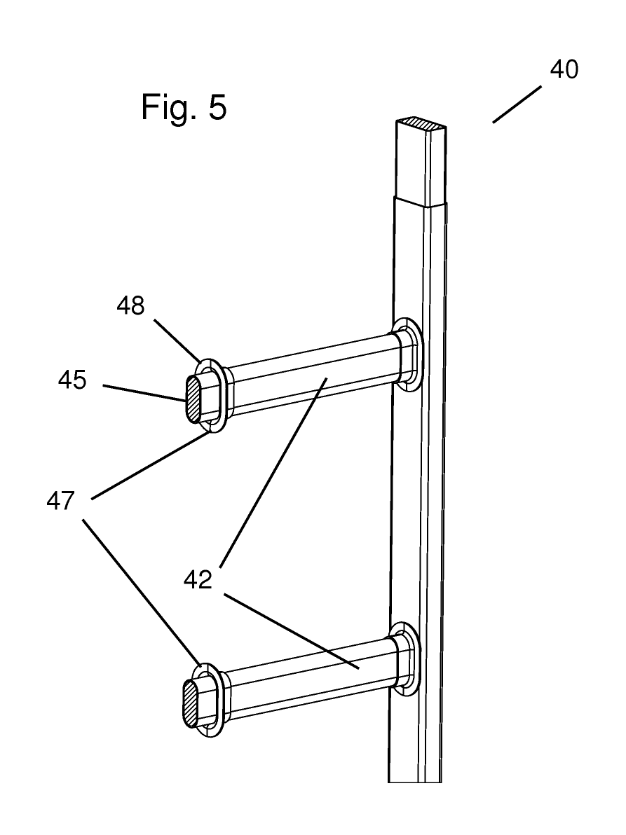

FIG. 5 shows two rungs 42 of the ladder/bridge 40 with one side-rail hidden. The rungs 42 in this embodiment may include a core material 45. A portion 48 of the rungs 42 carries through the inside surface of the side support tubes 41 and is bonded to the interior of the opposite face. This ties the entire assembly together and prevents the rungs 42 from shearing off. To further increase bonding surface area and strength, flanges 47 are preferably fabricated to match the contour of the rungs 42. In preferred embodiments, the flanges 47 are carbon fiber flanges. The structure 40 is assembled by first sliding the rung 42 through the left side support 41, then sliding on the flanges 47, and finally attaching the right side support tube 41.

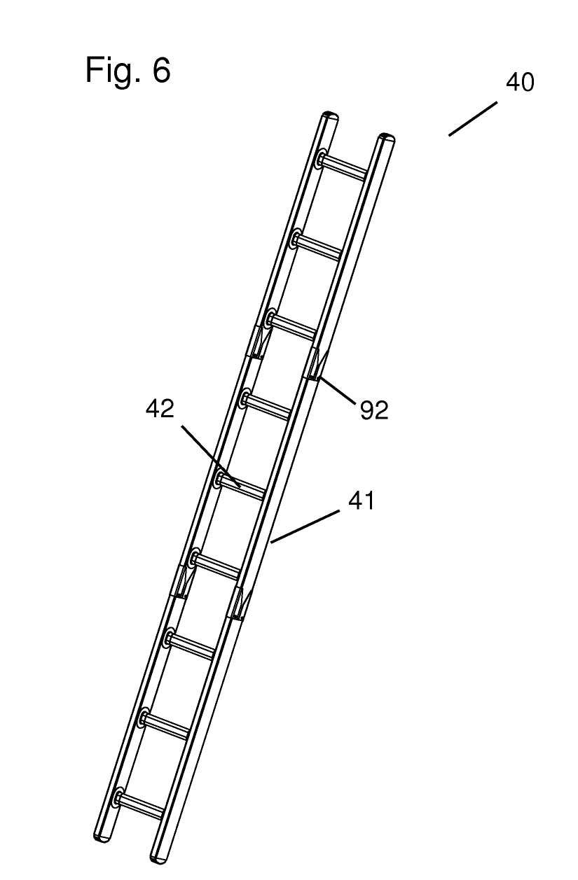

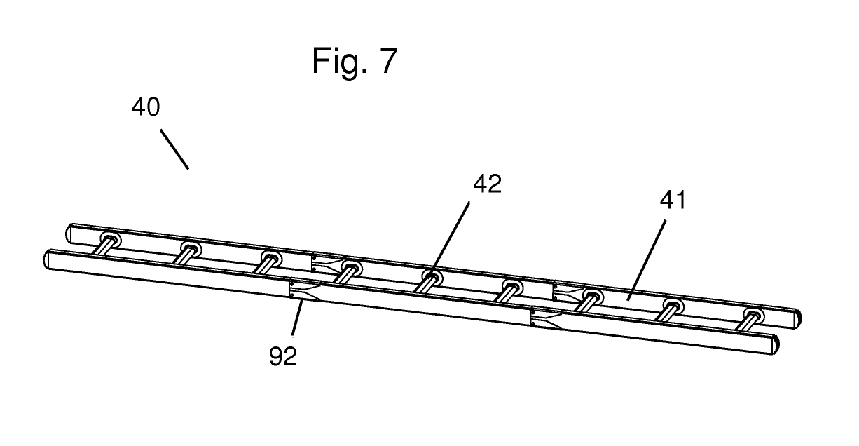

An assembled three-section structure 40 is shown in FIG. 6 in a vertical ladder use configuration, and in FIG. 7 in a horizontal bridge use configuration.

The structures of the present invention are particularly useful because of the segmentation of the components. The entire modular structure is composed of smaller pieces, each one a separate ladder/bridge section (also described as a ladder segment herein), which are put together at the time of use. While the structure includes pieces made of carbon fiber in some preferred embodiments, the modular ladder/bridge system of the present invention could alternatively be manufactured out of other lightweight materials, such as fiberglass, aluminum, or titanium, or any combination of these and other materials. The individual pieces, or any combination of them, may be used as a ladder, a bridge, or another structure. For ease of fabrication and assembly, all components can be made identical. For assemblies with greater than two sections, the only difference is elimination of the splices at the terminal ends.

One example of a ladder/bridge of the present invention is a five-section, 32-foot ladder weighing approximately 35 pounds. For scaling vertical obstacles, the user can choose to use 1, 2, 3, 4, or all 5 sections, depending on the height of the obstacle. This unit could also be used as two or more smaller ladders simultaneously by multiple individuals. The individual sections could then be used either alone or with any combination of other sections, and be placed horizontally across a gap, for example between buildings or over a small ravine or canal. Once all users are safely across, the bridge can be pulled up by a single individual due to its light weight carbon-fiber tubular construction.

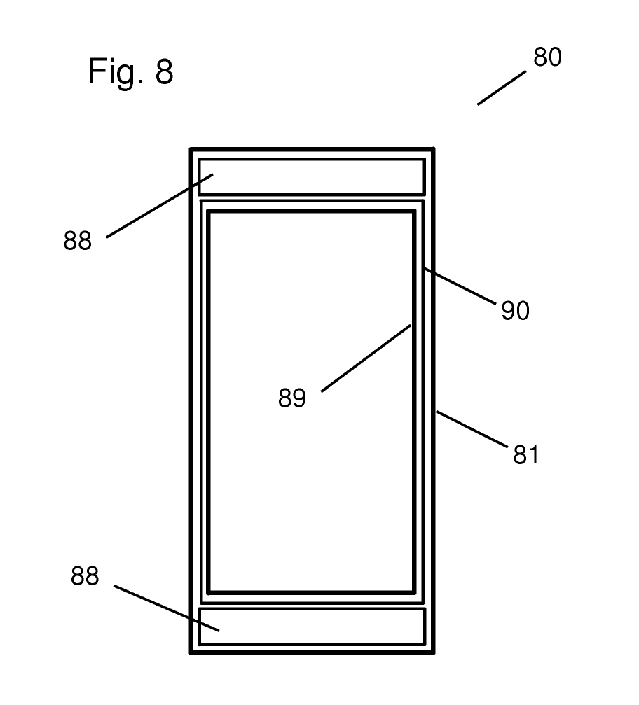

A novel method fabricates the main support beams 80, shown in FIG. 8. Pultruded carbon-fiber strips 88 are placed within carbon-fiber tubes to add significant tensile and bending strength. In a preferred embodiment, the pultruded carbon-fiber strips 88 are preferably approximately rectangular in shape, although other shapes are also possible. The strips 88 are placed within the composite layup and sandwiched between layers 81, 89, and 90 of carbon-fiber woven material. In a preferred embodiment, the strips 88 are uni-directional carbon fiber strips 88. In another preferred embodiment, a layer of braided or plain-weave material is used for the inside surface 89 (inner carbon fiber layer) of the tube 80, followed by layers of uni-direction carbon-fiber fabric 90 (uni-directional carbon fiber), and then a layer of braided material for the outside layer 81 (outer carbon fiber layer) of the tube 80. Pultruded carbon fiber strips 88 are preferably placed between the braided carbon fiber layers 90 and 81 (or, in the embodiments where there is no uni-directional carbon-fiber fabric layer 90, between the braided carbon fiber layers 89 and 81) and held in place once the adhesive cures. In one preferred embodiment, the uni-directional carbon-fiber strips 88 are placed on a maximum of two opposing sides of the tube. In one embodiment, the adhesive is epoxy, but any adhesives that could be applied to carbon fiber tubes and efficiently adhere the layers could alternatively be used.

In applications where bending strength is needed about a single axis (for example, bending of the carbon-fiber ladder/bridge), pultruded carbon fiber strips 88 can be placed along only the top and bottom beam surfaces, but excluded from the sides. In some preferred embodiments, the uni-direction carbon-fiber fabric 90 wrapped around the inner carbon-fiber layer 89 is excluded, leaving only the outer 81 and inner carbon-fiber material 89 and the pultruded carbon-fiber strips 88. During fabrication, the pultruded carbon-fiber strip 88 may be one solid piece on each side, or composed of two or more pieces for ease of fabrication. Also, by stacking the strips 88 on top of one another, additional wall thickness can be easily accomplished, resulting in higher beam stiffness and strength. This method of construction results in a lightweight beam with exceptionally high stiffness and strength along a single bending axis.

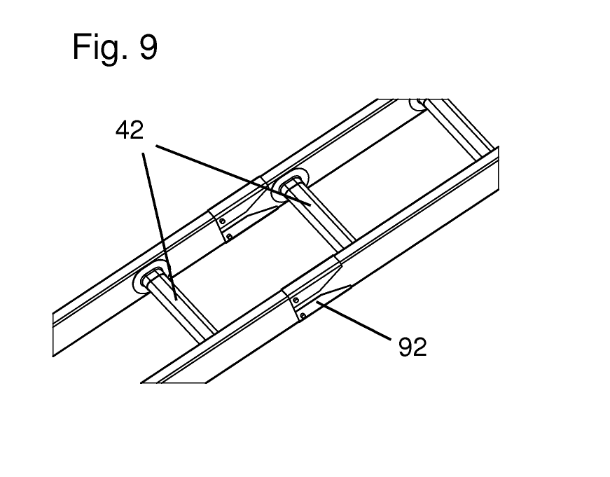

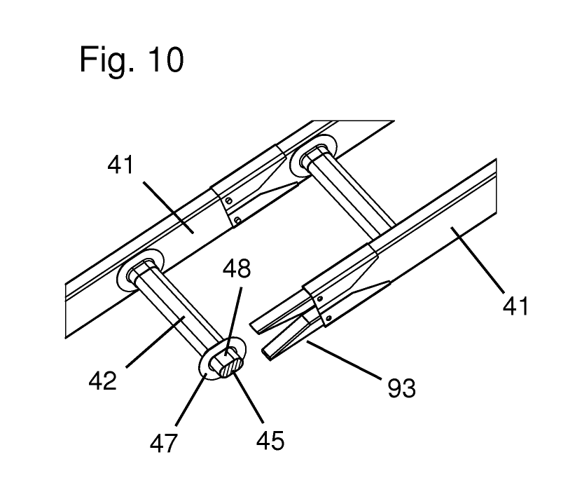

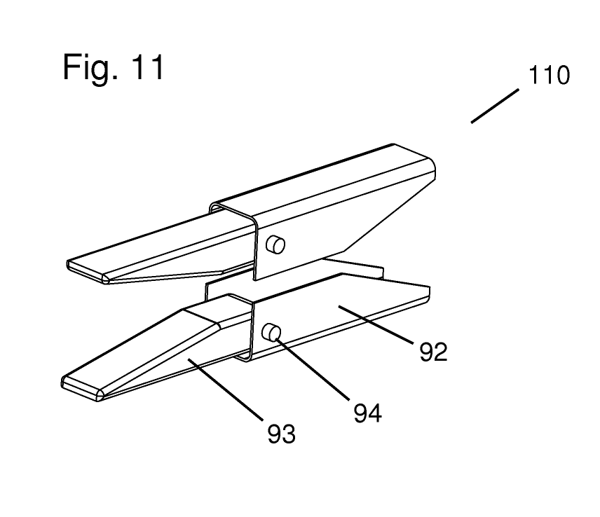

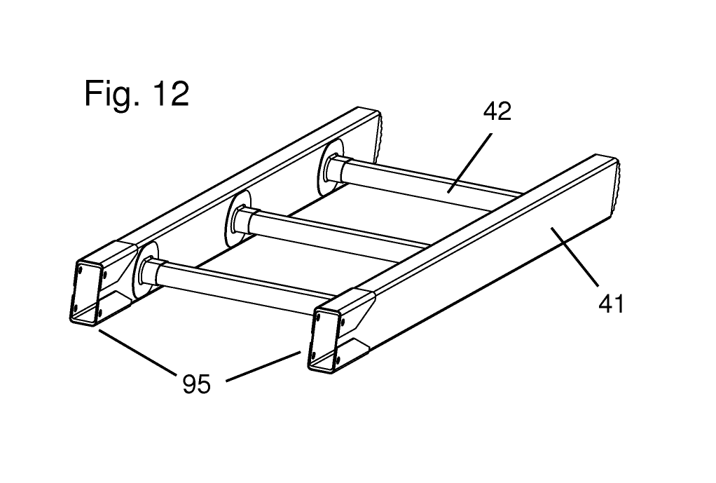

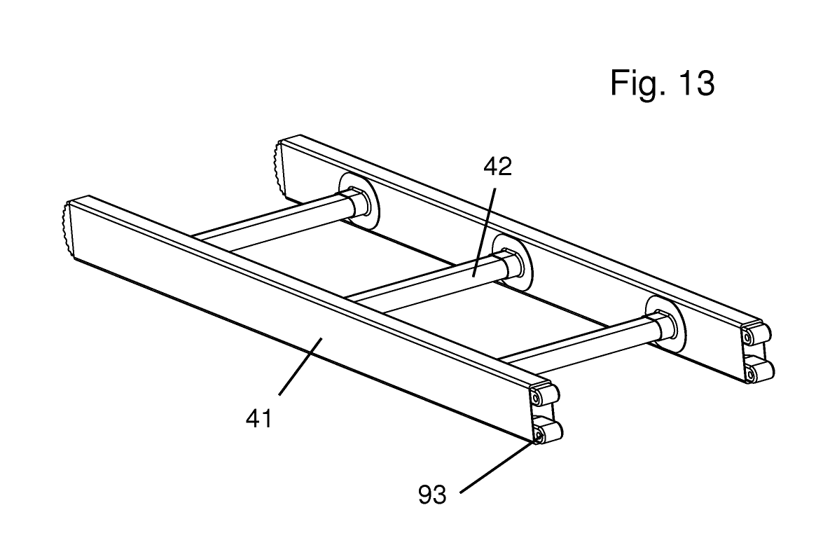

FIG. 9 shows a close-up near a joint of a ladder/bridge 40, depicting the rungs 42 and reinforcement gussets 92. FIG. 10 shows a portion of the ladder/bridge 40 with one side-wall tube made transparent, revealing the internal joint connectors 93 bonded within the side-beam tube 41. The joint connectors 93 are preferably made of fiberglass, but they could alternatively be made of other lightweight, strong materials, including, but not limited to, aluminum or titanium. FIG. 11 shows a basic assembly of this type of joint 110. The gussets 92 are placed on the opposite (female) side of the joint for added wall strength. Pins 94 are inserted to hold the joined components together when in use. The complete female ladder segment connection 95 is shown in FIG. 12. FIG. 13 shows the mating male segment side 93. The individual ladder/bridge segments are assembled by sliding the internal joint connectors 93 into the mating end 95 of the adjoining segment, lining up the joint connector holes, and inserting two pins 94.

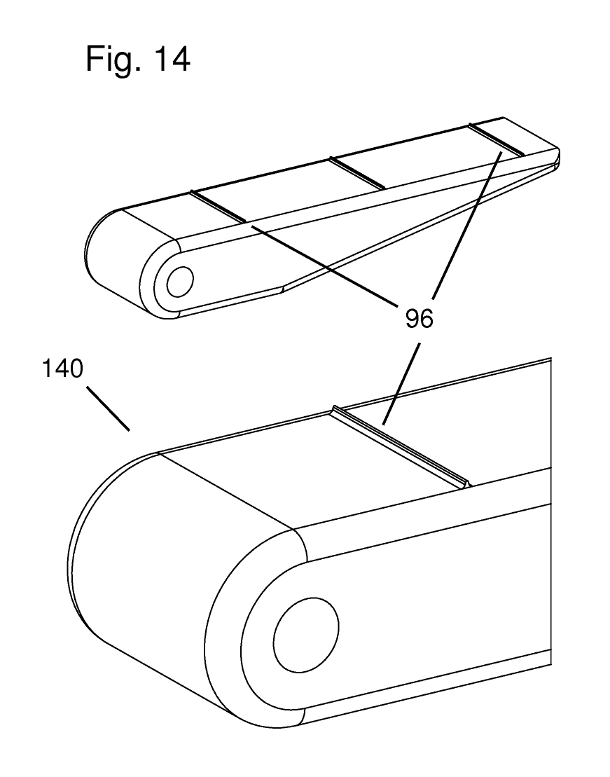

An alternative internal joint connector 140 with ridge guides 96 is shown in FIG. 14. The ridge guides 96 are preferably fabricated as part of the internal joint connector 140. This joint connector 140 would replace the male segment side 93 of the joint connector 110 shown in FIG. 11. The joint connector 140 allows proper spacing of the internal connector piece away from the tube inner wall to maintain sufficient adhesive thickness. In one embodiment, the joint connector 140 is preferably made of fiberglass. Alternatively, the joint connector 140 may be made from any other lightweight, strong material including, but not limited to, aluminum or titanium.

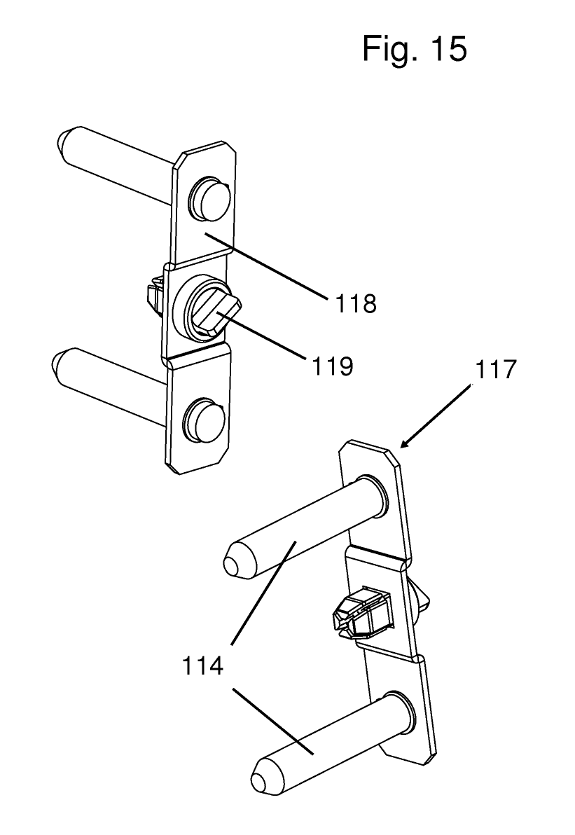

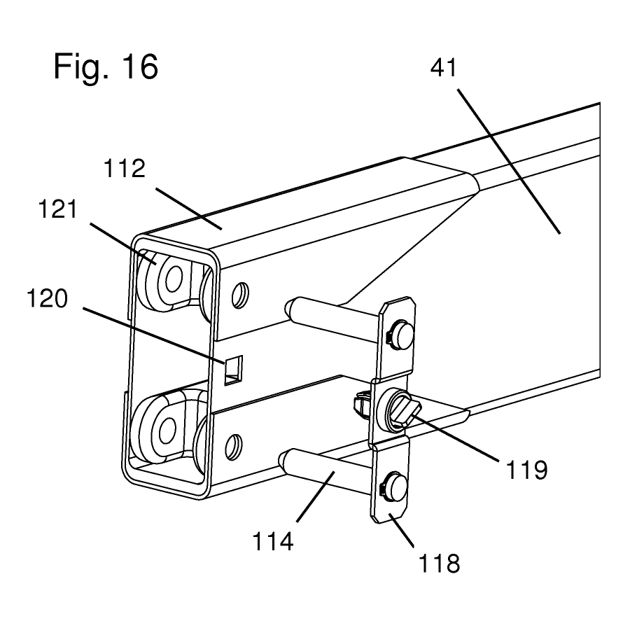

One embodiment of a pin joint connector is a dual-pin connector 117, as shown in FIG. 15. This design includes two pins 114 rigidly connected to a metal or composite bracket 118. In the center of the connector is a fastener 119, which engages with a hole 120 in the side of the outer surface of the main ladder beam 41, as shown in FIG. 16. In a preferred embodiment, the fastener 119 is a Zeus-type turn fastener. When the fastener 119 is fully engaged and turned, the pin connector 117 locks in place to prevent the ladder segments from sliding apart.

An alternative female internal connector 121 is also shown in FIG. 16. The outer reinforcement bracket 112 can optionally be used here; however, the primary load path now goes through the female internal connector 121.

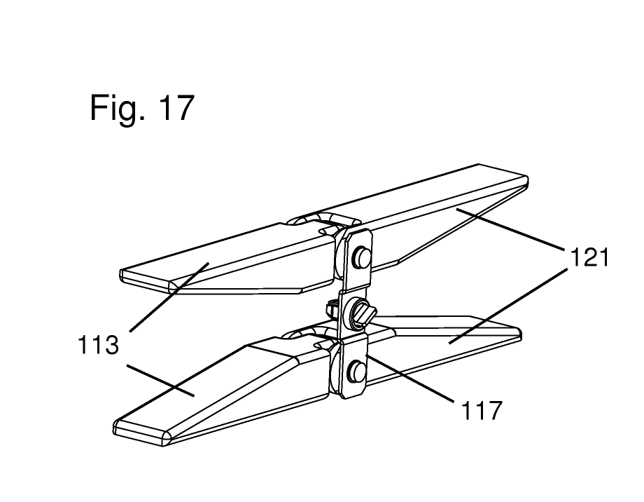

Insertion and final placement of the two-pin connector 117 in the assembly is shown in FIG. 17. Here, the side-beams are hidden to show only the male and female internal connectors 113 and 121, and the dual-pin connector 117. When the structure is disassembled, the pin connector 117 can be stored in place in the segment holes, or retained by a tie or line affixed to the structure.

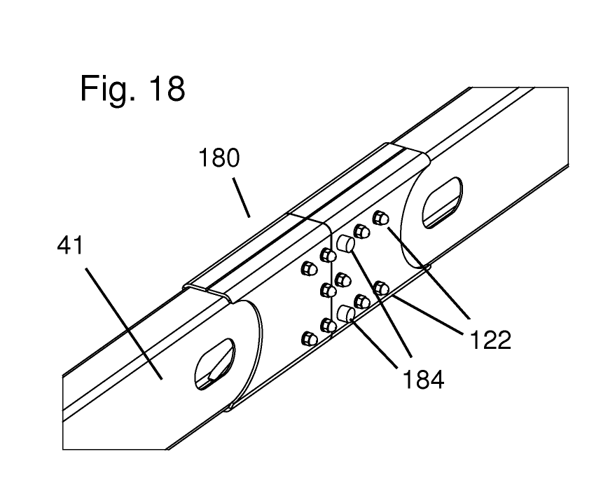

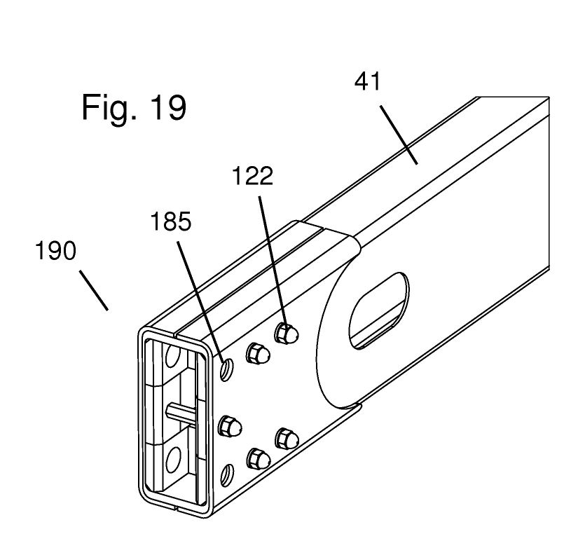

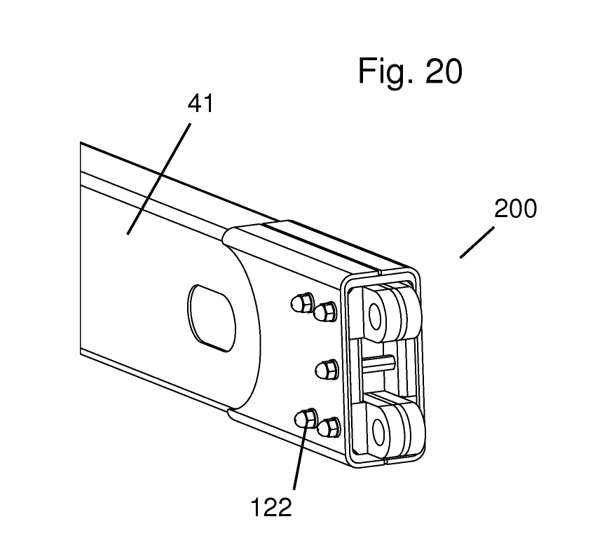

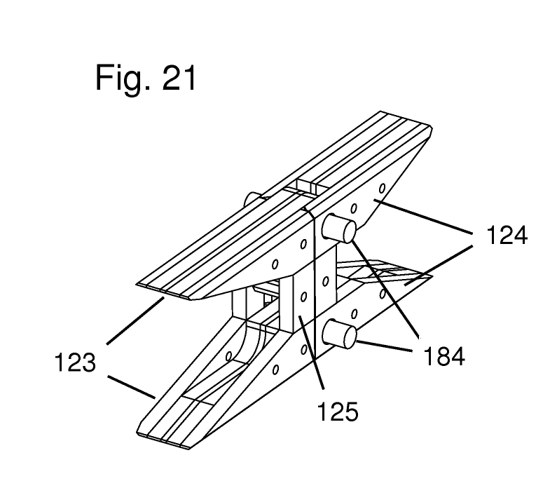

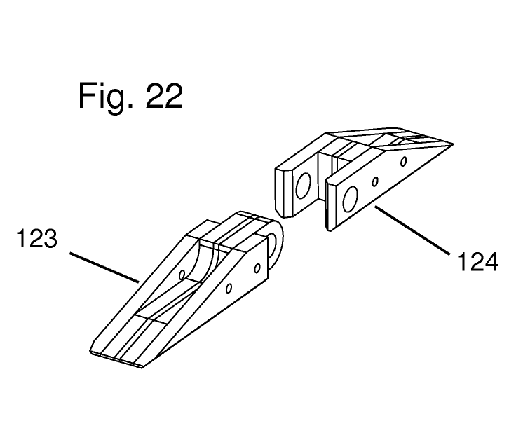

FIGS. 18 through 22 show an alternative embodiment of internal joint connectors. FIG. 18 shows the complete joint 180. Here, additional mounting hardware (for example, bolts, washers, and/or nuts) 122 are permanently mounted to each side beam 41 through the internal joint connectors for added safety. Pins 184 make the connection through holes 185 between the two joining segments. FIG. 19 shows the female segment end 190 for the joint connector 180 and FIG. 20 shows the male segment end 200. The male 123 and female 124 internal joint connectors are preferably fabricated from multiple machined flat plates, as shown in FIG. 21. By using a flat-plate construction, volume machining costs are reduced. In between the male 123 and female 124 internal connectors are shear support pieces 125. These pieces act as the web of an I-beam, reducing the shear stresses in the side-walls of the carbon fiber tubes 41. FIG. 22 shows a single male internal connector 123 and a single female internal connector 124 before the connection is made.

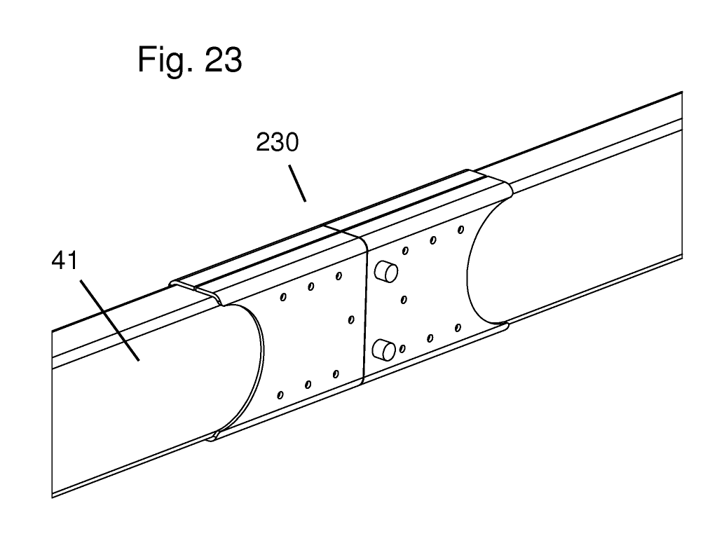

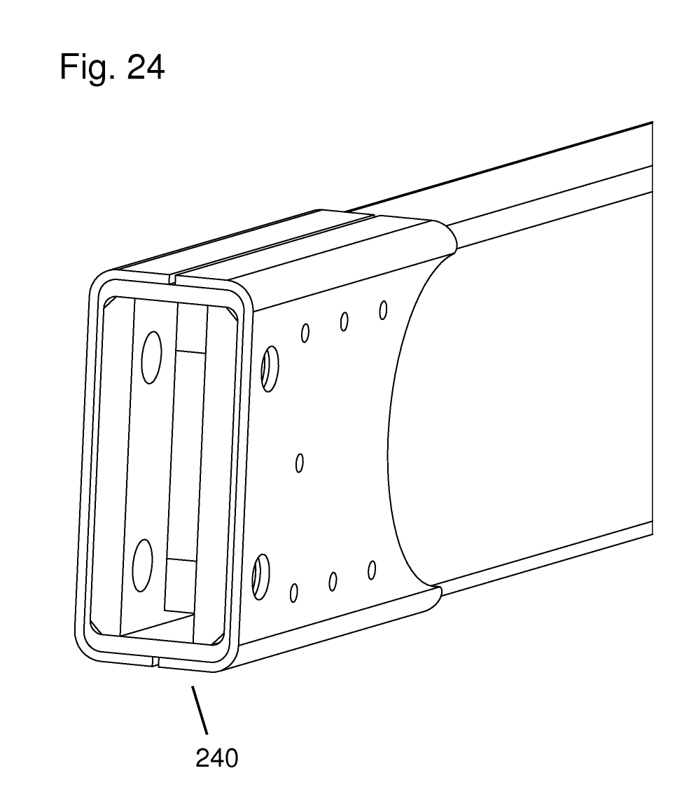

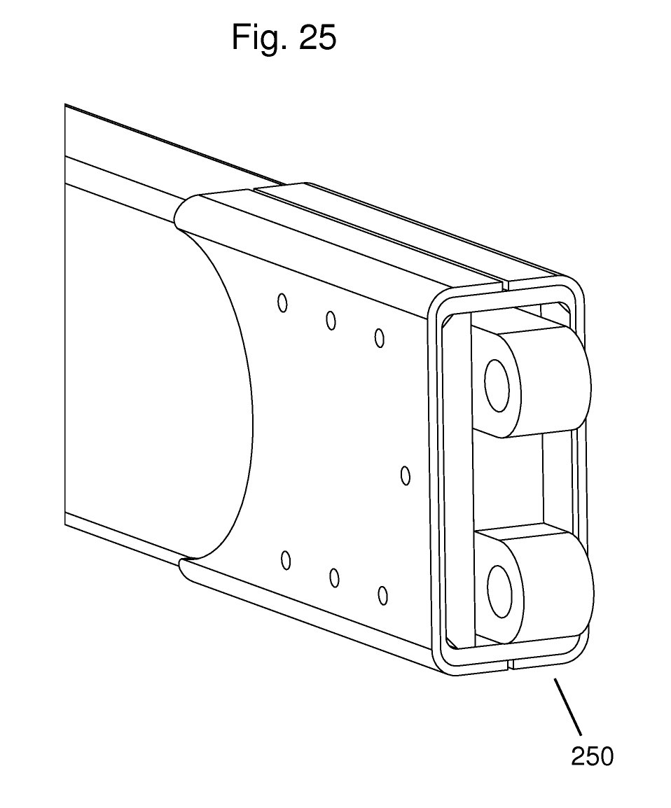

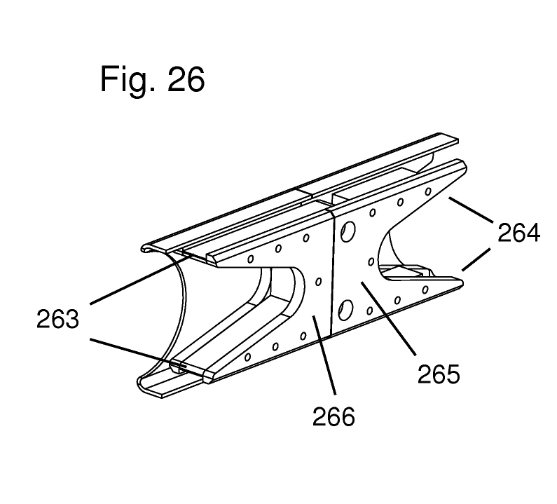

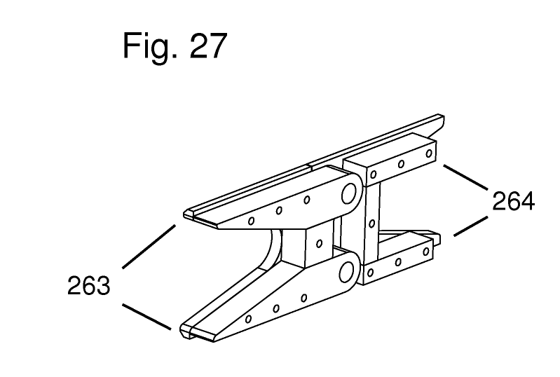

FIGS. 23 through 27 show another embodiment for the internal joint connectors. FIG. 23 shows the complete joint 230. FIGS. 24 and 25 show the female 240 and male 250 connector ends, respectively. FIG. 26 shows the male 263 and female 264 internal joint connectors connected to each other. FIG. 27 shows a male internal connector 263 and a female internal connector 264 with brackets (which are made of carbon-fiber in a preferred embodiment) and front components hidden. In this embodiment, the joints are again made up of flat-plate machined components. Unlike the design shown in FIG. 21, however, where the shear web 125 is a separate piece, the flat components 265 and 266 on the outer walls in this embodiment include the top and bottom components, as well as the shear web. This reduces the number of machined parts.

While the joint connectors 93, 140, 117, 180, 230 discussed herein are preferably used in the modular ladder/bridge system of the present invention, any of the joint connectors 93, 140, 117, 180, 230 could alternatively be used in any structure or modular system that required connections between two separate pieces with interior portions, for example a beam including but not limited to, a rail, an I-beam, or a tube. In one preferred embodiment, the joint connectors connect two tubes with interior hollow portions or more specifically, two composite tubes. More preferably, the tubes are carbon fiber tubes. A tube, as defined herein, is a long hollow object. As an example, any of the joint connectors could be used to connect pieces of a truss structure.

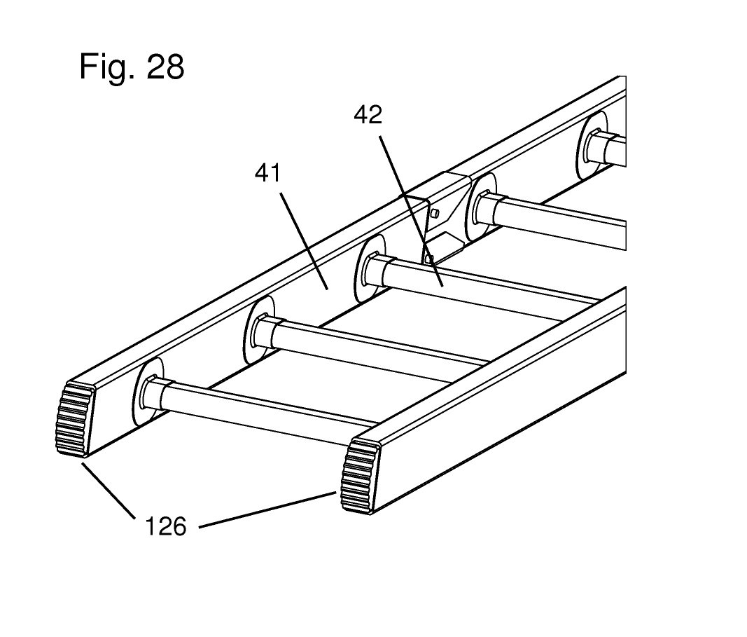

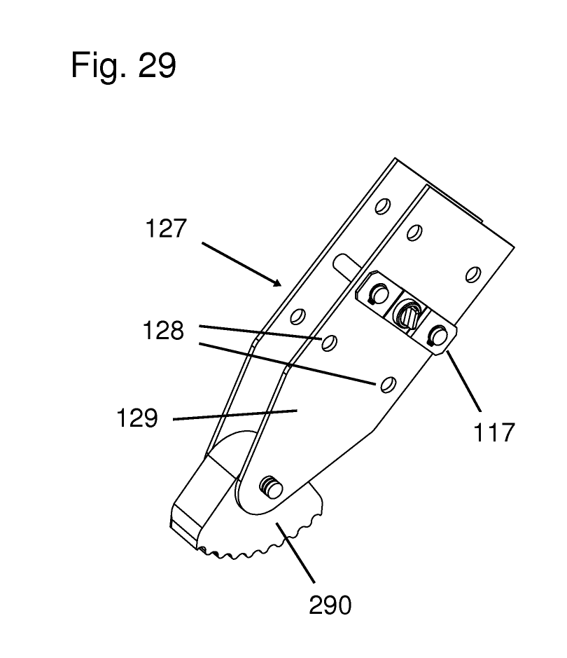

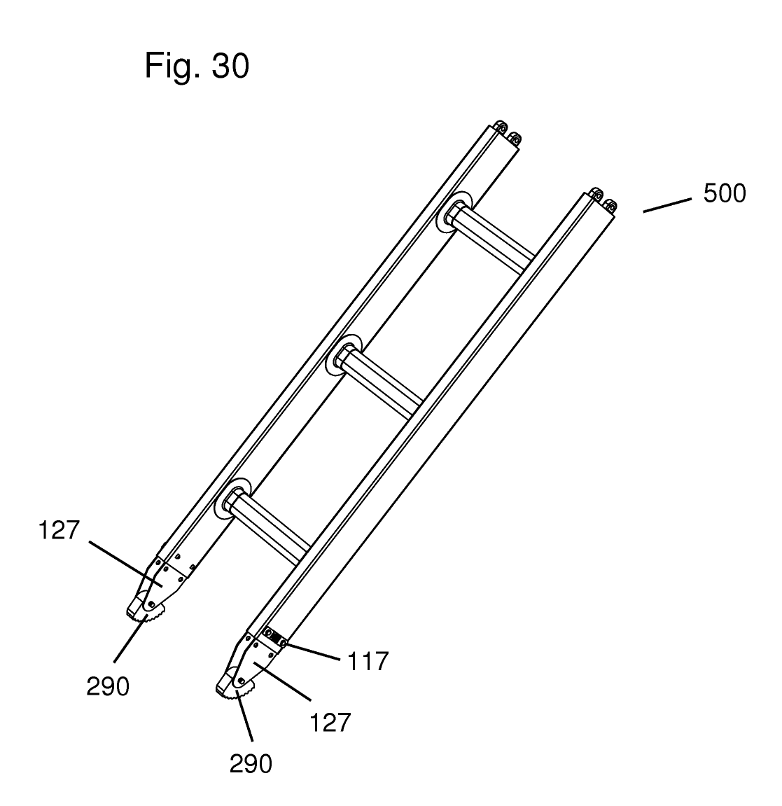

At the two terminal ends of the structure, either permanently mounted feet or removable base pieces are used. FIG. 28 shows one example of permanent feet 126, which preferably take the form of molded plastic or rubber inserts bonded into the inside of the main beams 41 with adhesive. Alternatively, removable pieces can be pinned in place. One embodiment of a removal and adjustable foot assembly 127 is shown in FIG. 29. These pieces may be adjustable to vary the height of the two side beams, for example in the event of uneven ground. Multiple mounting hole positions 128 in the foot support bracket 129 allow the pin 117 to be placed in the most desirable position for each application. This also allows the foot 290 to be completely removed from the end of the structure if necessary. FIG. 30 shows a terminal ladder segment 500 with removable/adjustable feet 290 installed.

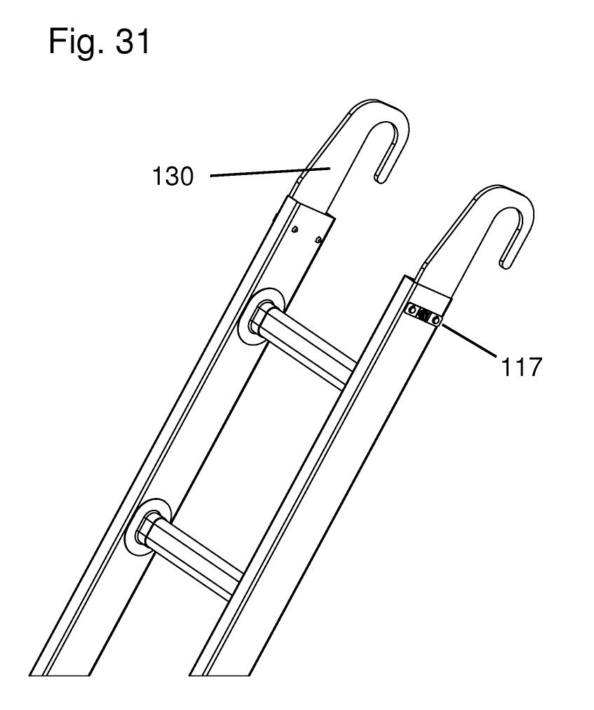

At the other terminal end of the structure, instead of feet 290, a ladder hook 130 can optionally be inserted and pinned into place, as shown in FIG. 31, for example, using the pin 117 shown in FIG. 15. Alternatively, other joint connectors, including, but not limited to those discussed herein, could be used to connect the hook to the structure. The hook 130 is another modular piece of the ladder/bridge system of the present invention.

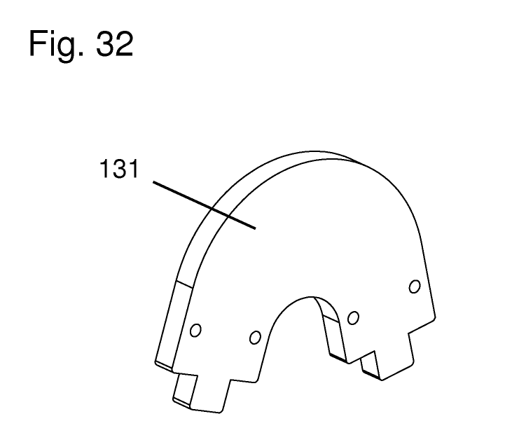

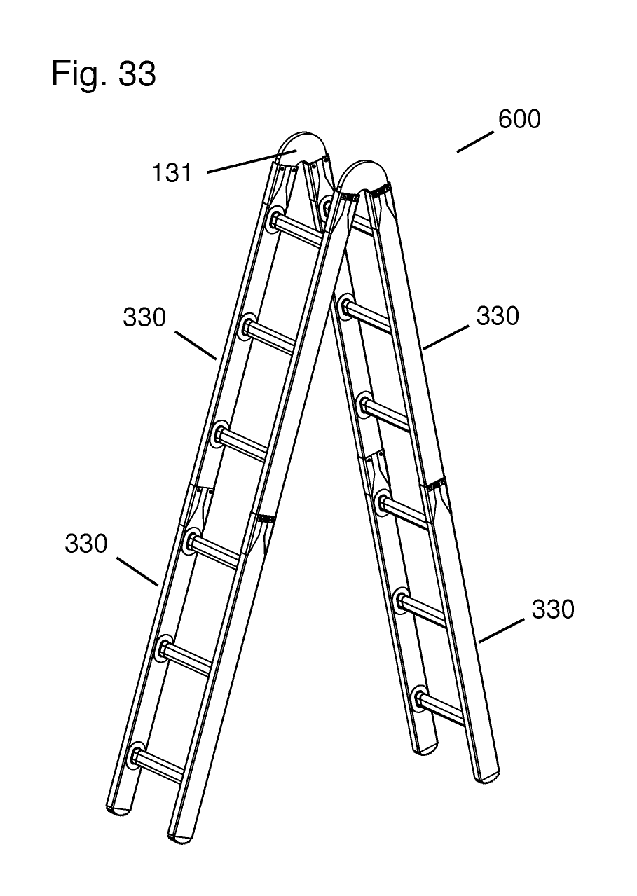

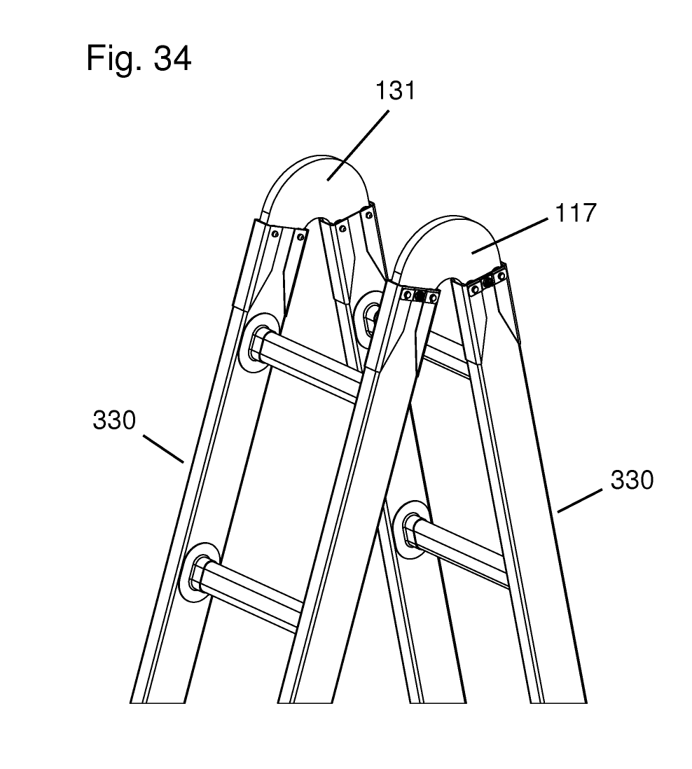

In addition to ladders and bridges, the basic building blocks of this system can be utilized to construct a myriad of other structures. For example, scaffolding, look-out stands, and tables can also be made by connecting multiple pieces together to form legs and platforms. To facilitate this, special angle connector pieces are preferably used. FIG. 32 shows an angle connector 131 used to combine the ladder segments into a step ladder 600, as shown in FIG. 33. In this case, four segments 330 (two on each side) are used to form the step ladder 600, with the step ladder connector 131 in place at the top. The connector 131 is preferably pinned in place and easily removable for disassembly. Alternatively, any number of ladder segments 330 can be used to form smaller or taller step ladders 600. FIG. 34 shows a close-up of the step ladder connector 131 in place on the ladder 600. The pin joint connector shown in FIGS. 16 and 17 is used to connect the angle connector 131 shown in FIG. 34. Alternatively, other joint connectors, including, but not limited to, the joint connectors discussed herein, could be used in combination with the angle connector 131.

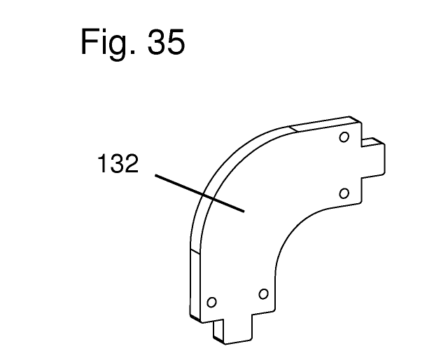

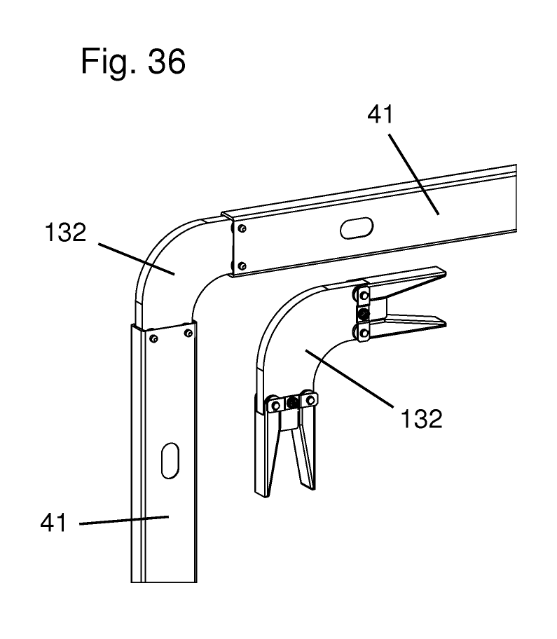

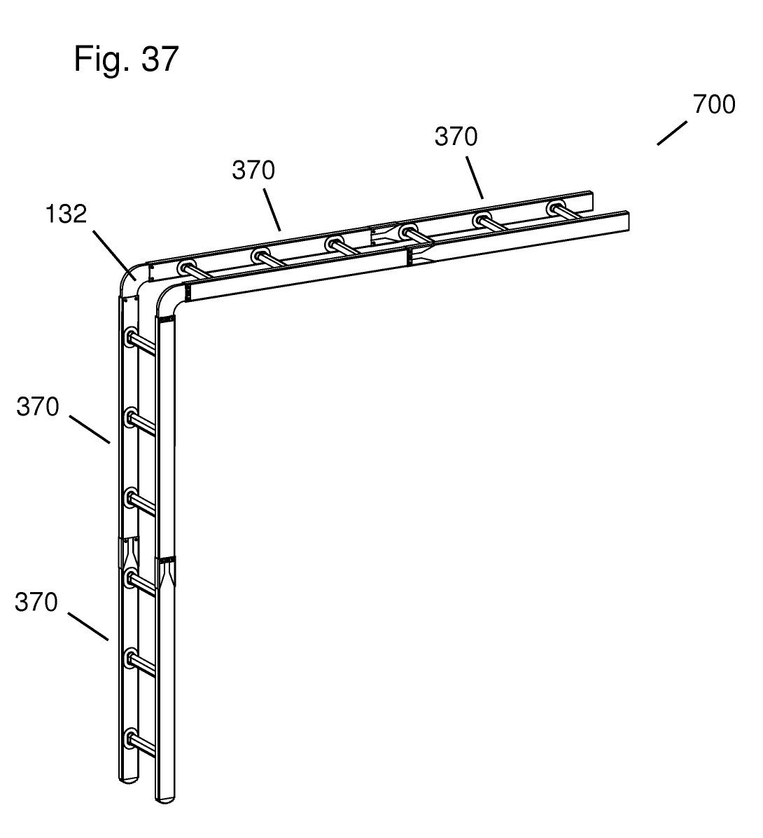

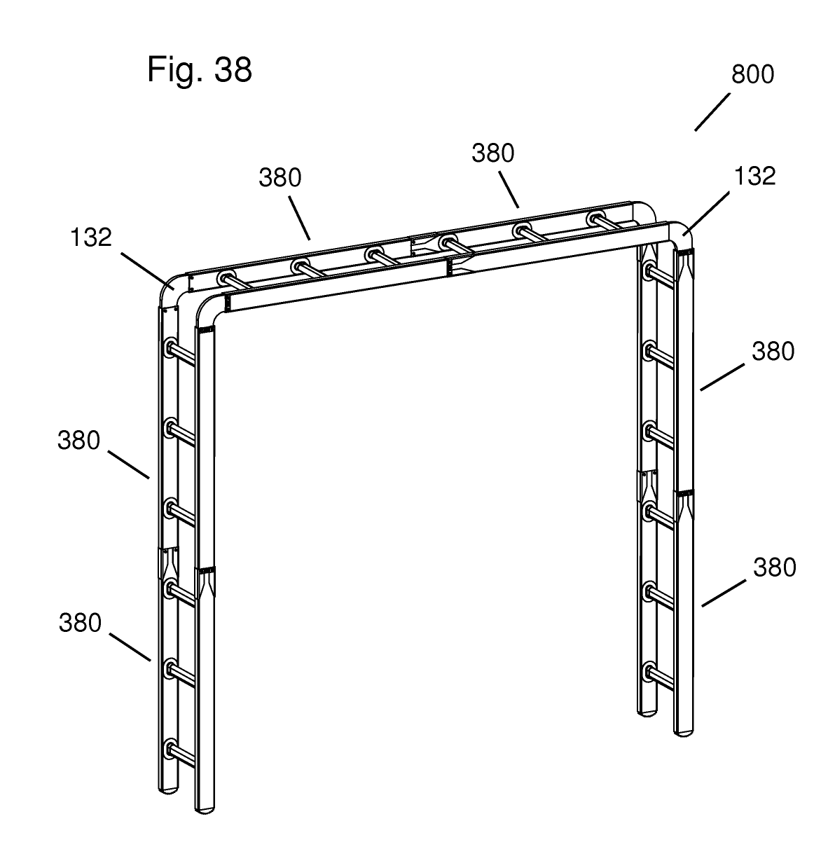

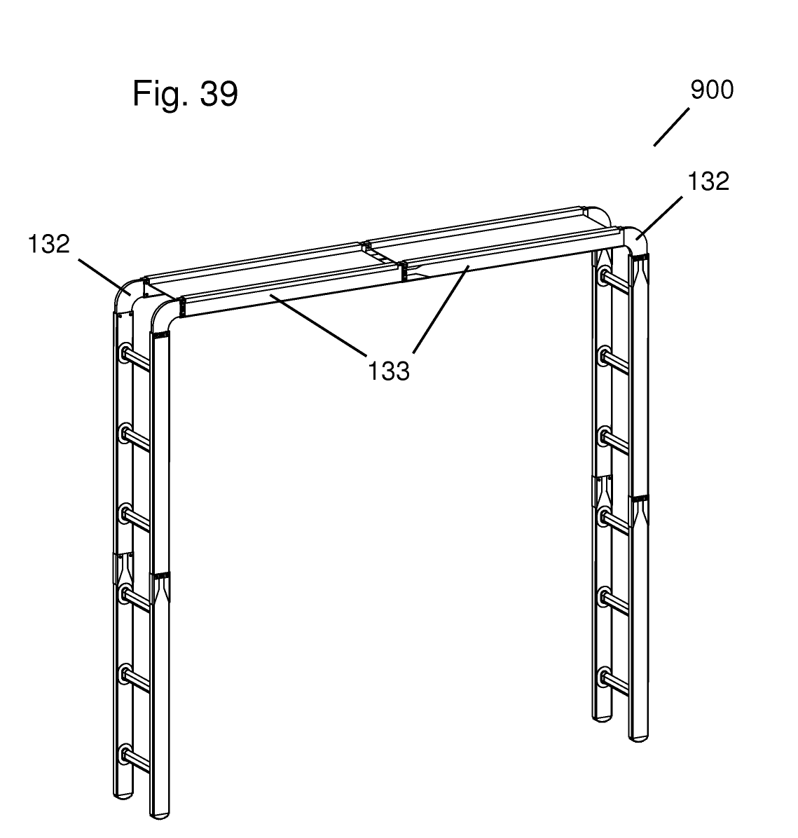

In order to form other structures, connectors of different angles are preferably used. FIG. 35 shows a 90 degree angle connector 132. Using this connector, structures with vertical and horizontal components can be constructed. A close-up of the 90 degree angle connector 132 in use is shown in FIG. 36. This connector is similar to the one shown in FIGS. 15-17, with the addition of the 90 degree angle portion 132. An assembled L-shaped structure 700 with four segments 370 is shown in FIG. 37. FIG. 38 shows a scaffold structure 800 with 90 degree connectors 132 and six segments 380. Both of these structures 700 and 800 are made possible by the ladder/bridge connector system discussed herein. In a preferred embodiment, to facilitate greater stability for the user, a solid panel 133 is preferably added over top of the rungs on the horizontal components, as shown in the scaffold structure 900 in FIG. 39. This provides better footing when standing on the top of the structure 900.

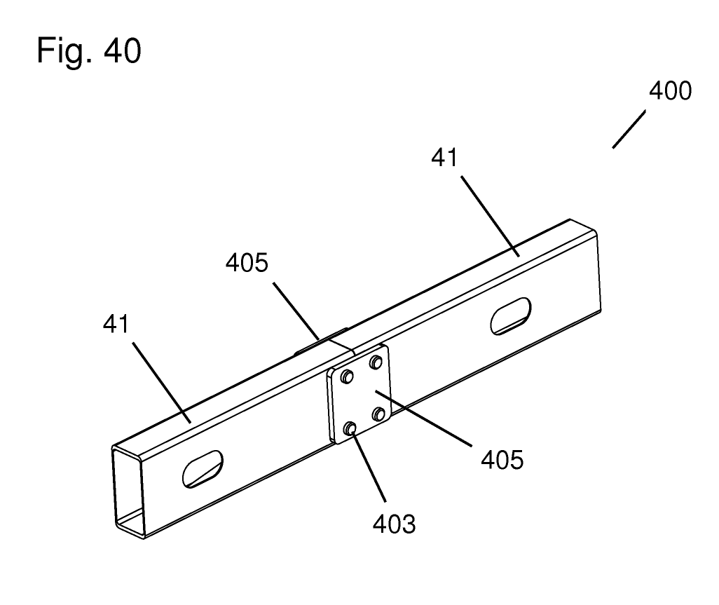

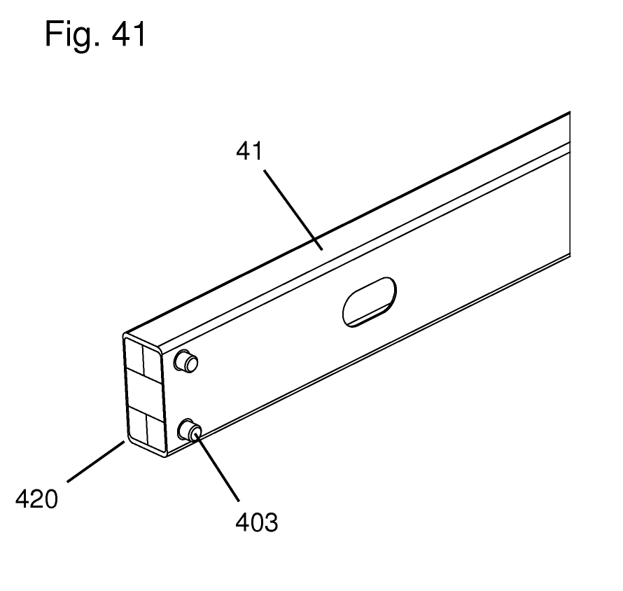

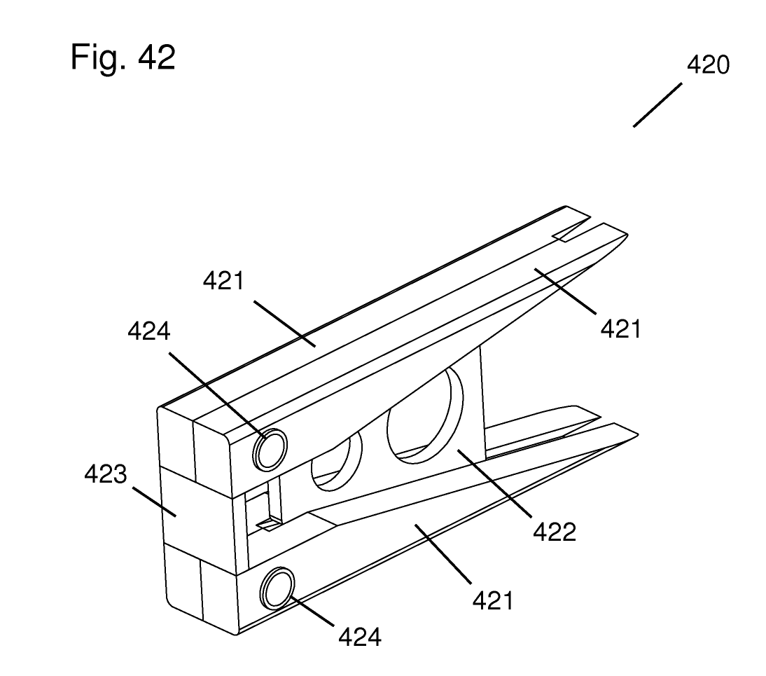

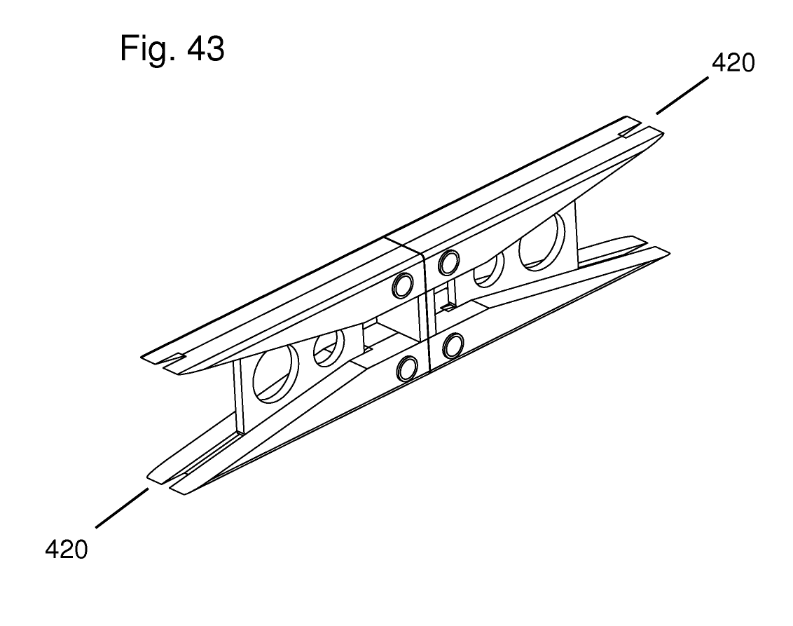

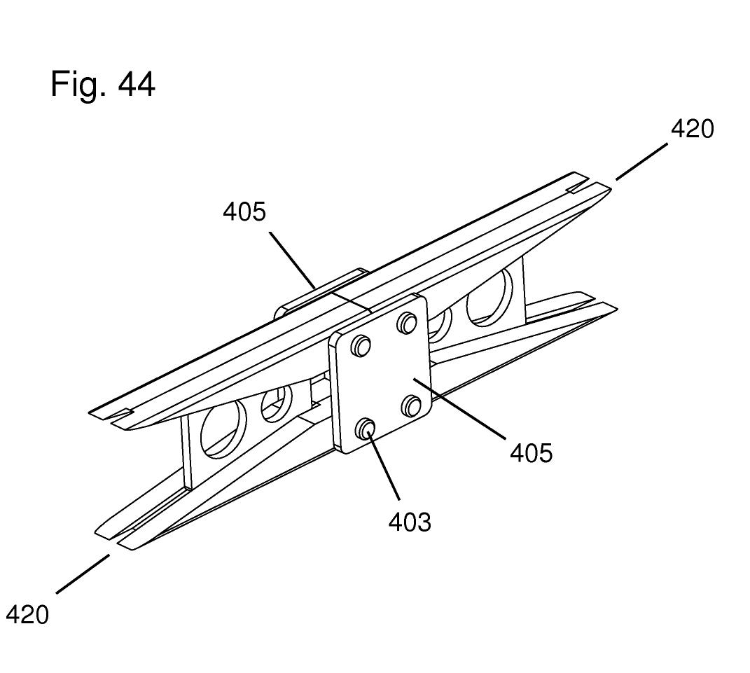

FIGS. 40 through 44 show another embodiment for the joint connectors. FIG. 40 shows a complete joint 400 between two beams 41. Beams 41 are held together using a set of plates 405 and pins 403. FIG. 41 shows one side of the joint 400, where the internal joint connector 420 is designed such that the mating portion is identical for each adjacent beam 41. FIG. 42 shows the internal joint connector 420 with the beam 41 hidden. In this embodiment, the joints are made up of longitudinal support pieces 421, a shear web 422, a vertical support piece 423, and bushings 424. FIG. 43 shows two internal joint connectors 420 mated together. FIG. 44 shows two internal joint connectors 420 connected using plates 405 and pins 403.

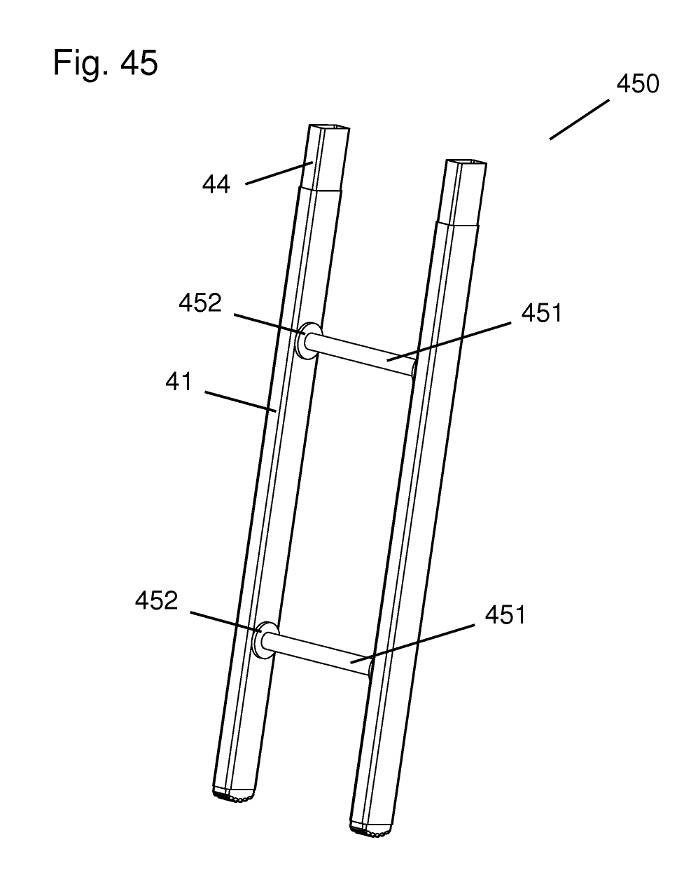

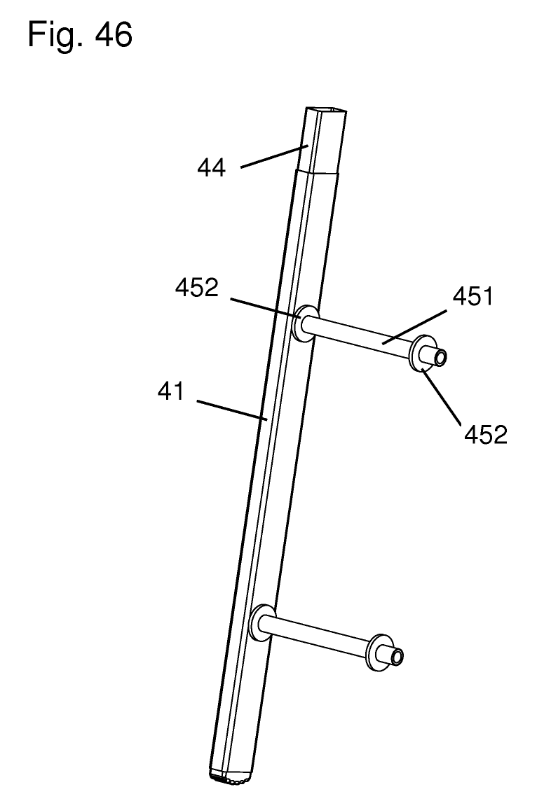

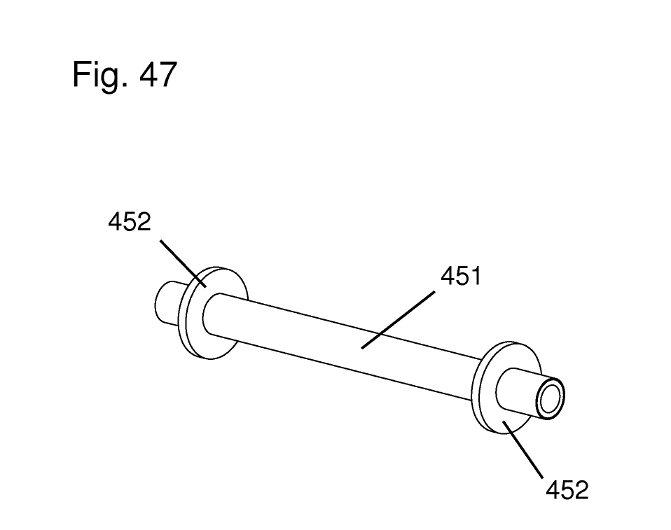

FIGS. 45 through 48 show another embodiment for a segmented ladder with an emphasis on reduced weight and ease of manufacturing. FIG. 45 shows an individual sleeved ladder section 450 with a sleeved joint. This section includes side beams 41, splice joints 44 that form splice connections, ladder rungs 451, and ring flanges 452. The splice joints 44 fit into a sleeve 60 (see FIG. 3) formed by a hollow portion inside the adjacent side beam 41. The ladder section shown in FIG. 45 differs from the embodiment shown in FIG. 4 due to the method of construction. FIG. 46 shows the ladder section of FIG. 45 with one of the side beams hidden. FIG. 47 shows a single rung 451 with two ring flanges 452. The ring flanges 452 are preferably manufactured by cutting ring-shaped pieces out of solid flat sheets of carbon fiber. Alternatively, the ring flanges 452 can be cut from thick-walled carbon fiber tubing.

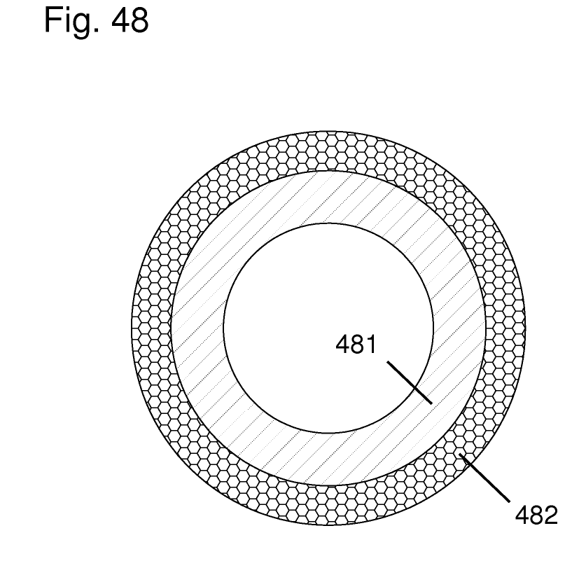

The rung 451 is preferably manufactured by taking a pultruded carbon fiber tube 481 and subsequently adding braided carbon fiber material 482 to the outer surface. This construction scheme is shown in FIG. 48. In addition to the braided carbon fiber material 482 added to the pultruded carbon fiber tube 481, other composite materials could also be added, either alone or in combination with the braided carbon fiber material 482, including, but not limited to, braided fiberglass and braided aramid fibers. The benefits of manufacturing the ladder in this way is that fabrication of the rungs and flanges is considerably less labor-intensive than producing custom molded shapes, while still maintaining the high strength and stiffness to weight ratio desirable in a carbon fiber structure.

Final assembly is performed by drilling holes in the side beams 41, sliding a rung 451 into one side beam, bonding the rung 451 against the inner wall of the side beam 41, sliding a ring flange 452 over the rung 451 and bonding it against the side beam 41. The same operations (in opposite order) are repeated on the opposing side of the ladder. Alternatively, the ring flanges 452 can be split in half, creating two half-circle pieces. This allows the ring flanges to be bonded in place after both side beams are in place.

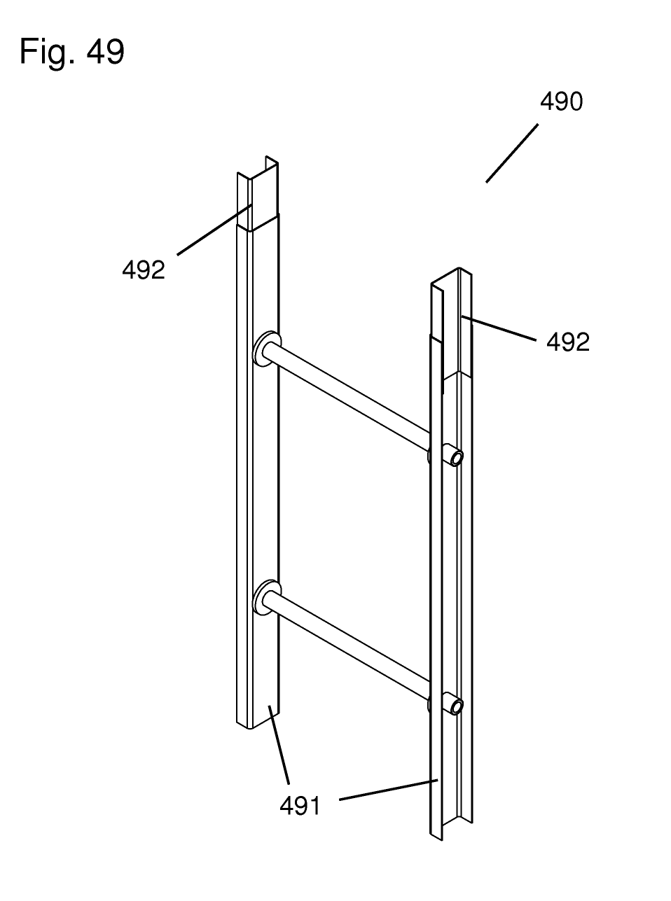

FIG. 49 shows another embodiment for a segmented ladder 490 where the side beams 41 of FIG. 45 are replaced by c-channels 491. Optionally, rectangular splices 44, shown in FIG. 45, can be replaced with c-channel shaped splices 492, as shown in FIG. 49.

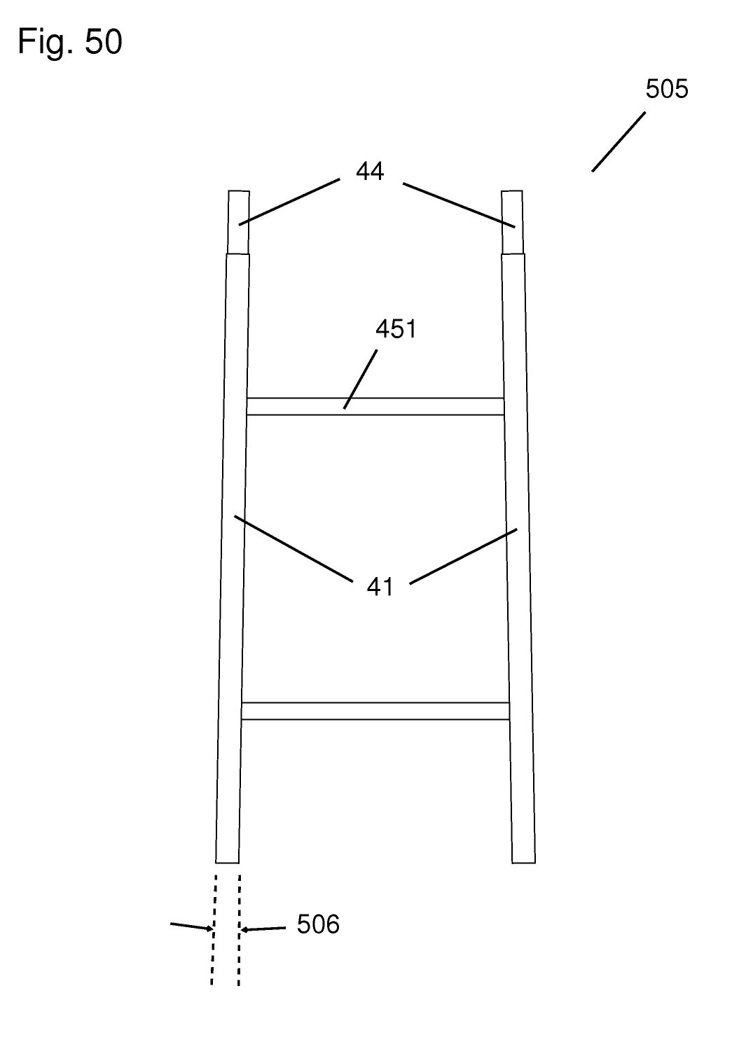

FIG. 50 shows another embodiment for a segmented ladder 505 where the side beams 41 are set at an angle 506 relative to the vertical direction. When multiple segments are connected together, this angle 506 provides a side force on the walls of the splices 44, which in turn produces a friction force that keeps the segments from sliding apart. Angle 506 is preferably between 1 and 3 degrees.

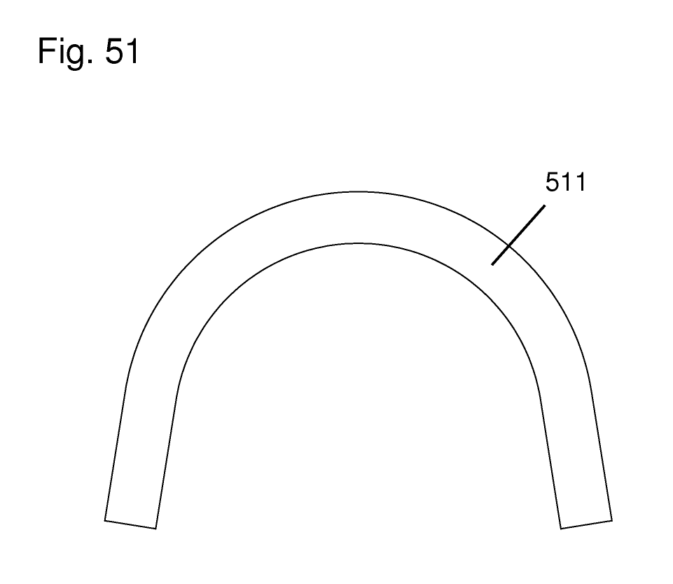

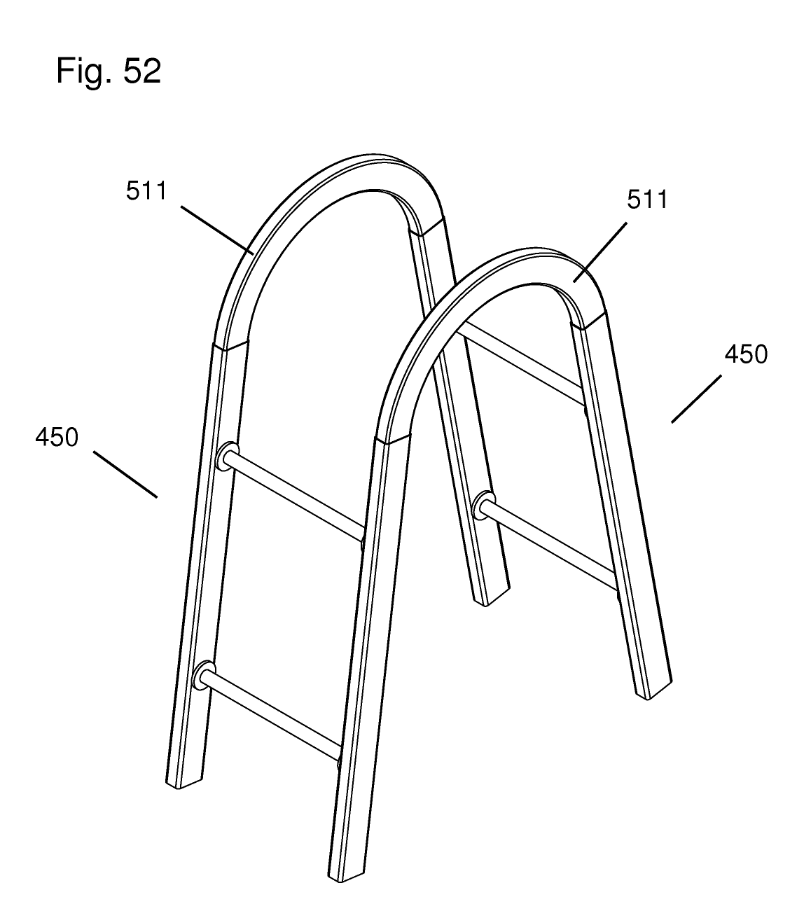

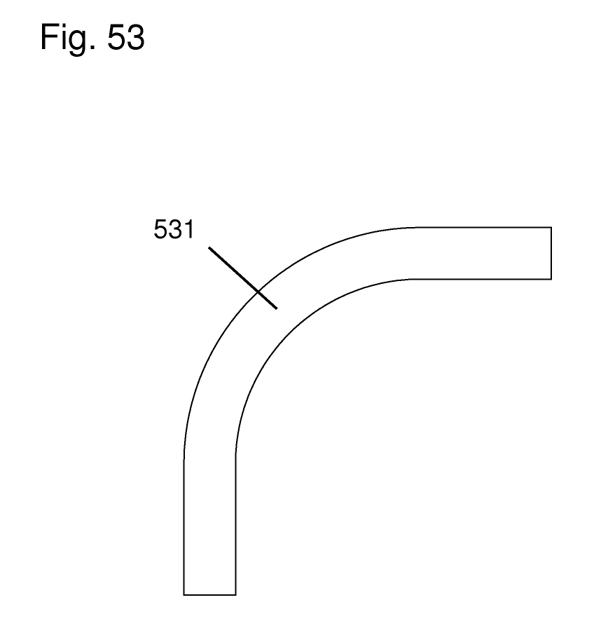

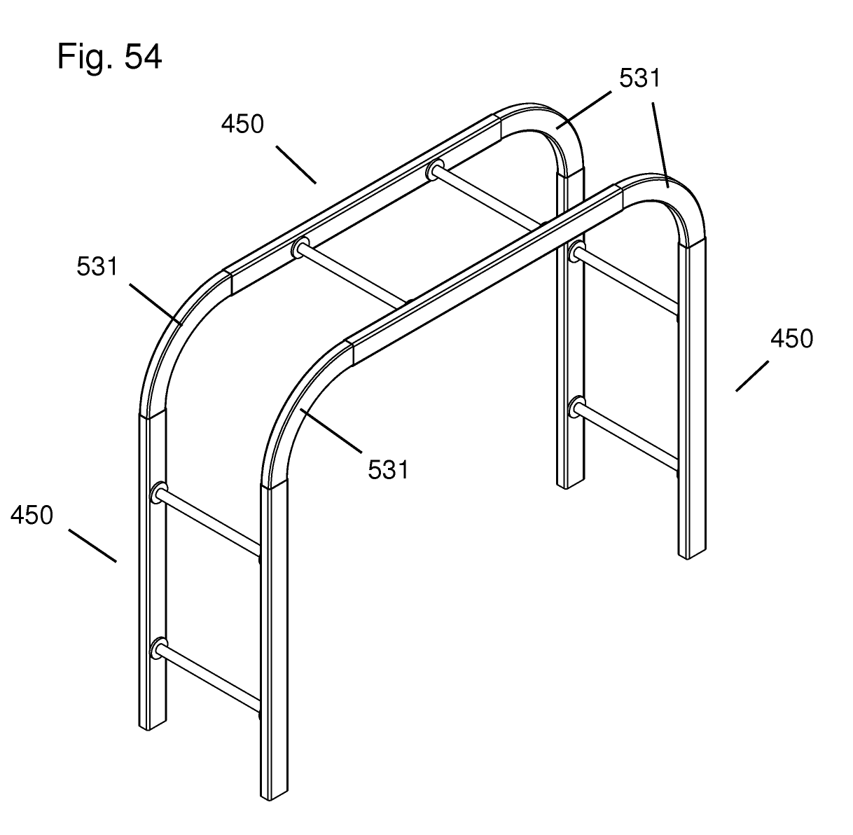

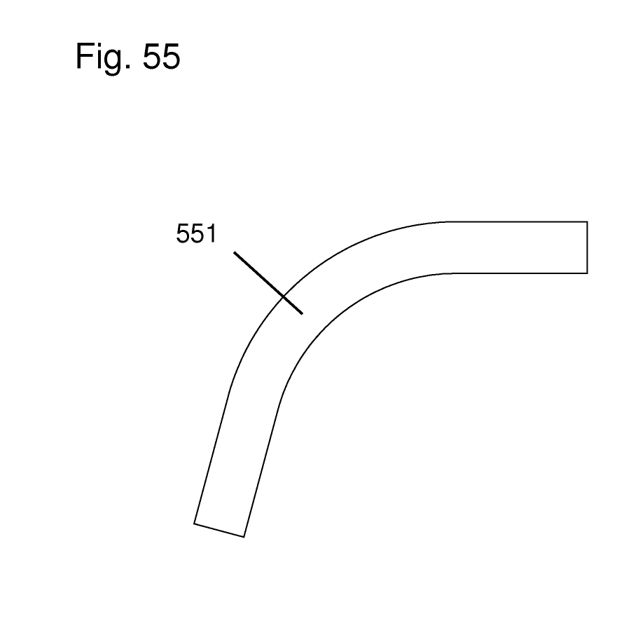

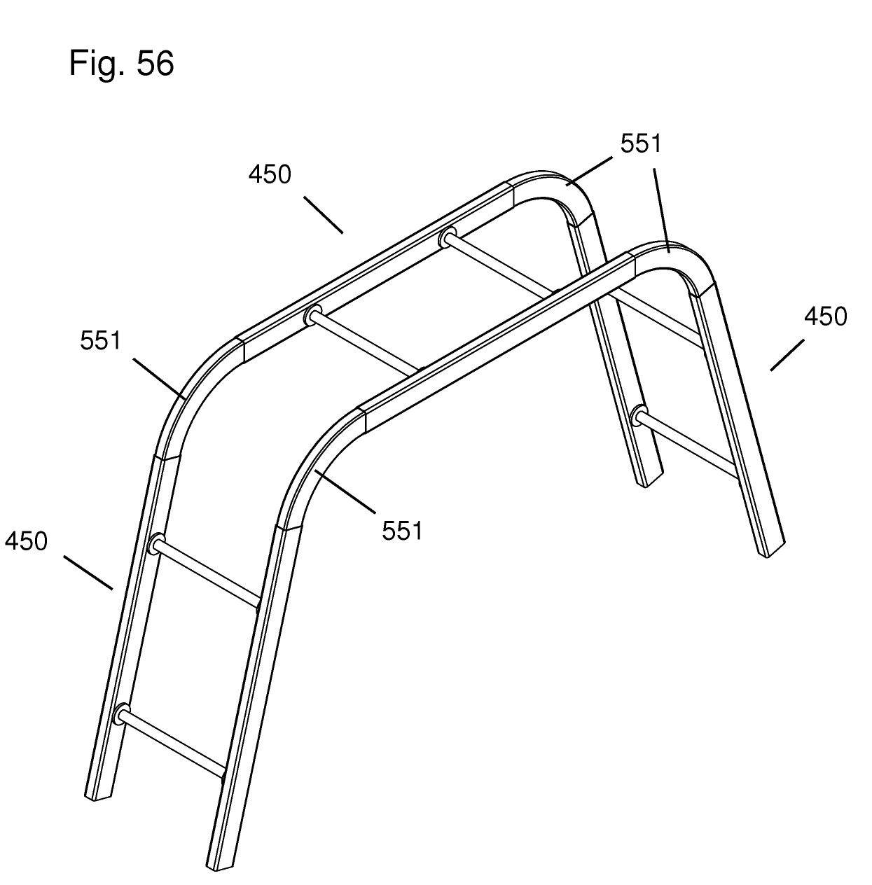

In addition to a segmented ladder, the ladder sections with sleeved splices 44 can be combined to form other structures, for example the types of structures shown in FIGS. 33-34 and 37-39. FIG. 51 shows an alternate design 511 for the connector 131. In FIG. 52, the connector 511 is shown connecting two ladder segments 450 to form a step ladder. Likewise, connector 531, shown in FIG. 53, can be used to create structures with both vertical and horizontal members. An example of this construction is shown in FIG. 54. Similarly, connector 551, shown in FIG. 55, can be used to create structures with horizontal and angled members, as shown in FIG. 56.

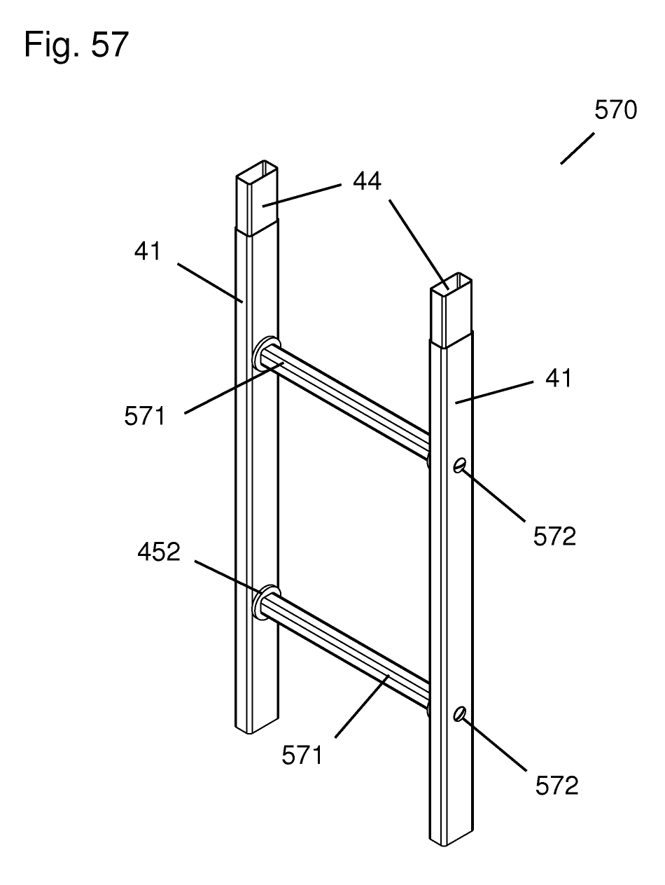

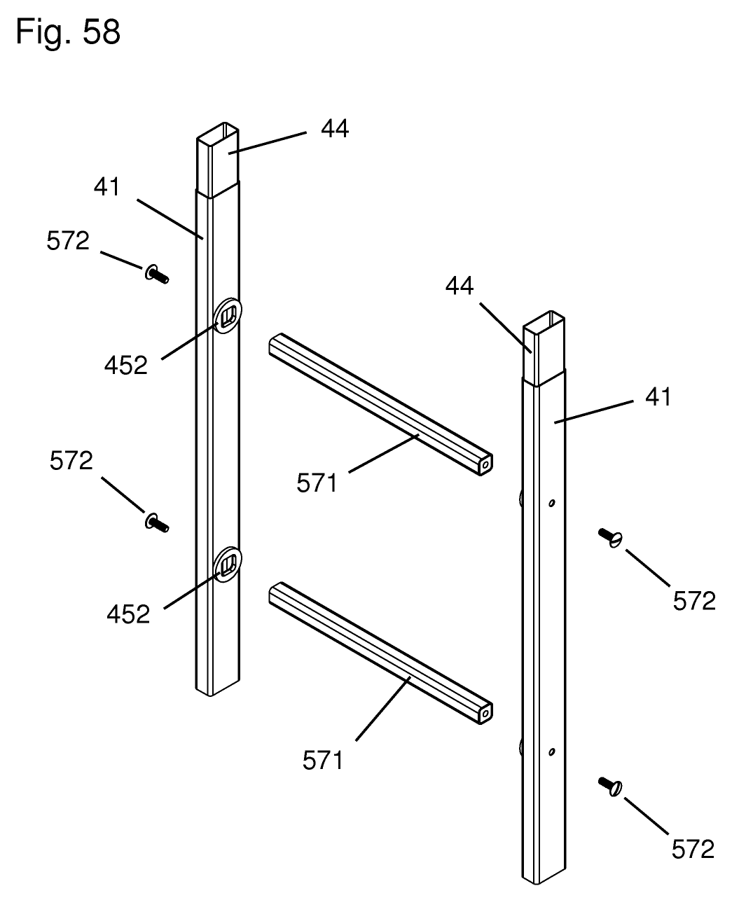

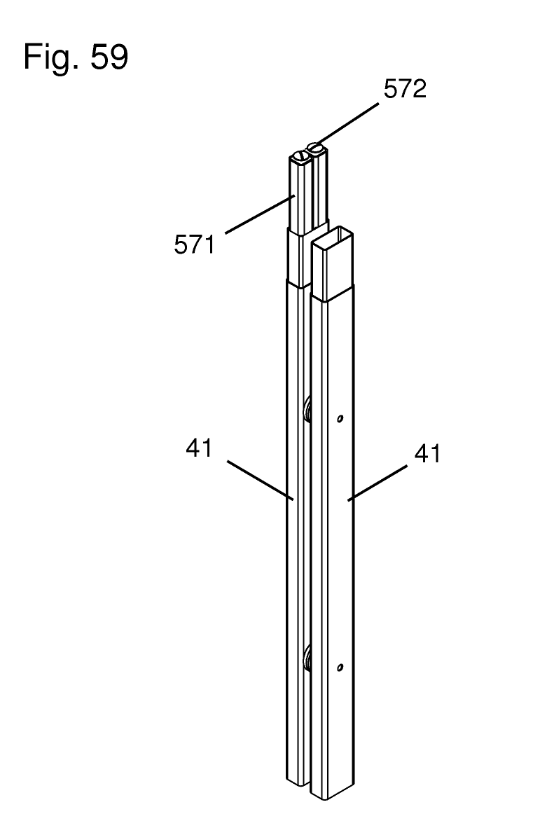

FIG. 57 shows another embodiment for a segmented ladder that allows complete disassembly and compact storage of the components. FIG. 57 shows an individual sleeved ladder section 570. This section 570 includes side beams 41, splices 44, ladder rungs 571, ring flanges 452, and fasteners 572. By unscrewing the fasteners 572, which are preferably fasteners including, but not limited to, bolts, captive fasteners, quarter-type fasteners, or quick-release mechanisms, the entire ladder segment disassembles into multiple smaller pieces. The fastener 572 engages into a mating receptacle located within the end of the ladder rungs 571. An exploded view of the ladder segment 570 showing the individual parts of the ladder segment is shown in FIG. 58. A preferred storage arrangement for the ladder segment components is shown in FIG. 59. Once an entire ladder is disassembled, the components can be stored in a bag or vehicle for easy transport.

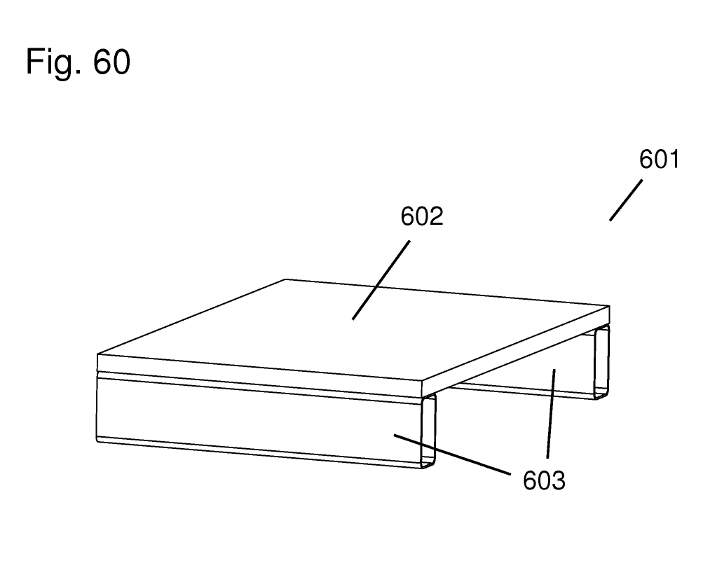

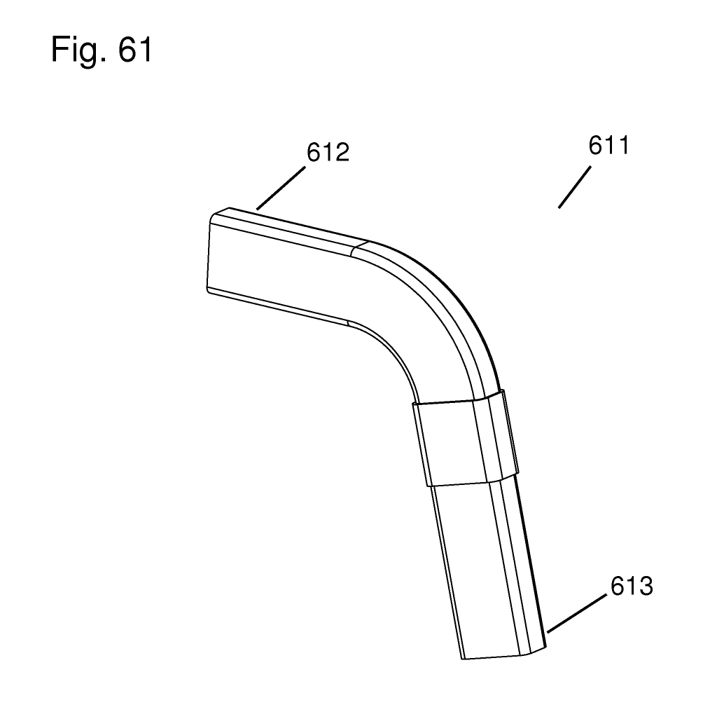

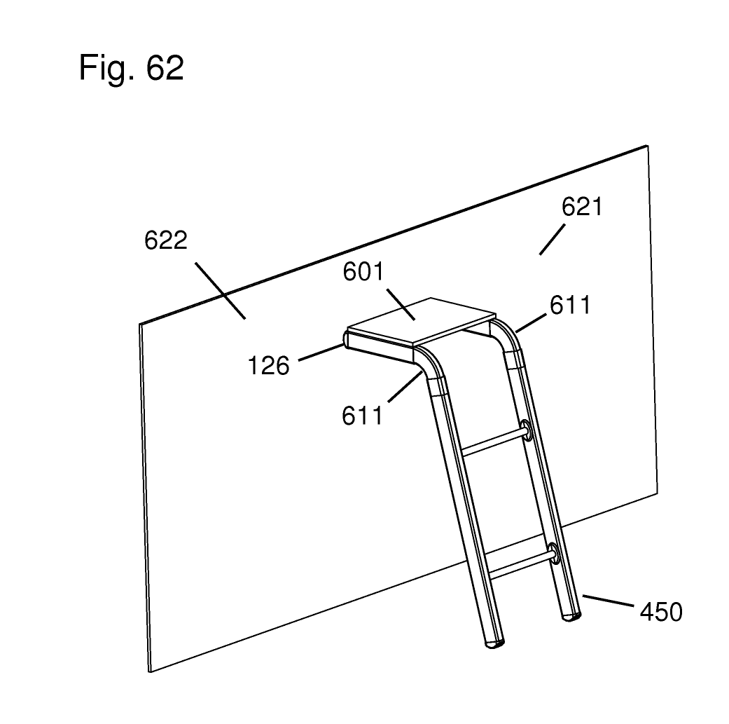

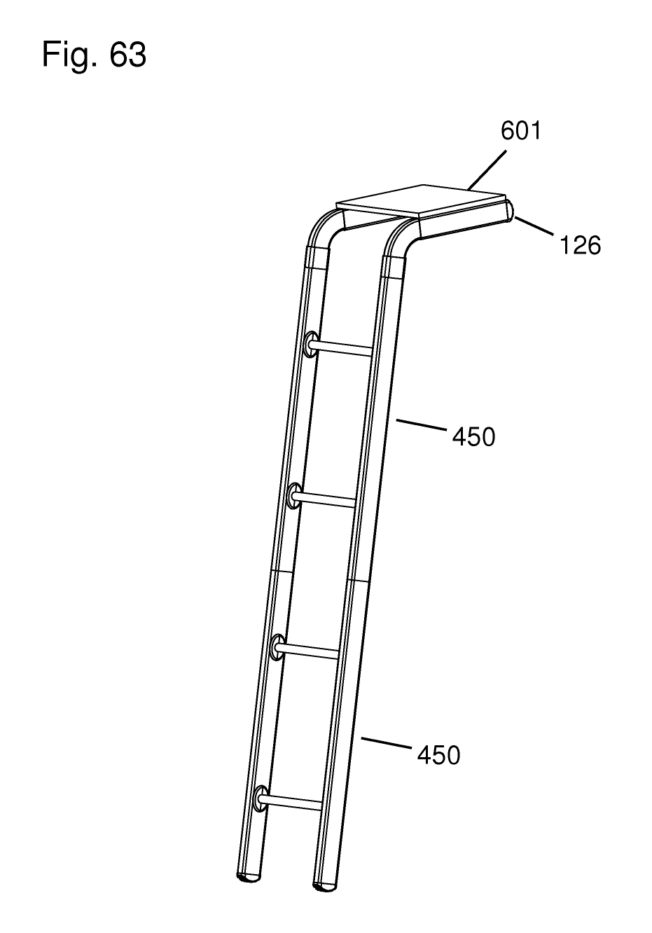

FIG. 60 shows a removable platform 601 useful for converting the segmented ladder system into a bus assault ladder/platform 621. The removable bus assault platform 601 includes a deck 602 and tubes 603, which are preferably made of carbon fiber. The complete bus assault accessory kit includes the removable platform 601 and two removable deck connectors 611, shown in FIG. 61. In some preferred embodiments, the removable deck connectors are made of carbon fiber. Each removable deck connector 611 has two ends 612, 613. The first end 612 mates with the tubes 603, while the opposite end 613 mates with a ladder segment 450, as shown in FIG. 62. The complete bus assault ladder/platform 621 is shown in FIG. 62 leaning against a wall 622, which could represent any vertical or nearly vertical surface, such as the side of a bus, train, truck, airplane, or building. The bus assault ladder/platform 621 is particularly useful in first floor porting operations, where a stable platform with a standoff distance from the wall is useful. A permanent foot 126 is preferably used for additional stability and traction against the vertical surface. For applications that require additional height, a second ladder segment 450 is preferably added to the ladder/platform 621, as shown in FIG. 63. In some embodiments, further sections are added for even higher targets, such as second floor entry or commercial airplanes.

In some preferred embodiments of the bus assault platform, the carbon fiber side rails or the carbon fiber rungs include an inner carbon fiber layer, an outer carbon fiber layer and a plurality of carbon fiber strips sandwiched between the inner carbon fiber layer and the outer carbon fiber layer. In other preferred embodiments of the bus assault platform, the carbon fiber side rails or the carbon fiber rungs include an inner carbon fiber layer, an outer carbon fiber layer, and a layer of uni-directional carbon fiber material surrounding the inner carbon fiber layer. In other preferred embodiments, the carbon fiber side rails or the carbon fiber rungs include an inner carbon fiber layer and an outer carbon fiber layer, where at least one of the inner and outer carbon fiber layers includes a braided carbon fiber material. In some of these embodiments, at least one layer of uni-directional carbon fiber material is placed between the inner carbon fiber layer and the outer carbon fiber layer. In some preferred embodiments, the carbon fiber side rails, the removable deck connectors, and/or the carbon fiber rungs are filled with a core material. In embodiments where the deck connectors 611 or the tubes 603 are made of carbon fiber, the deck connectors 611 or the tubes 603 may also or alternatively have any of the preferred carbon fiber material constructions described in this paragraph.

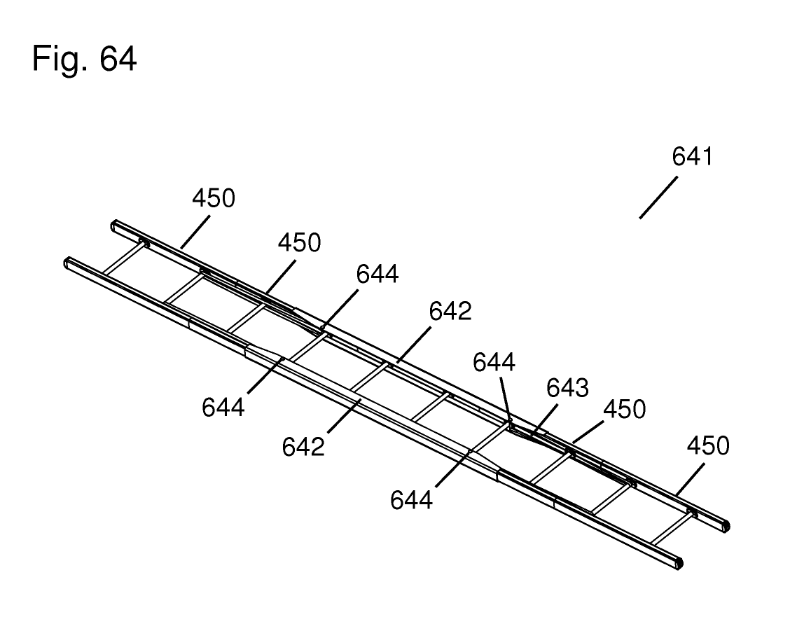

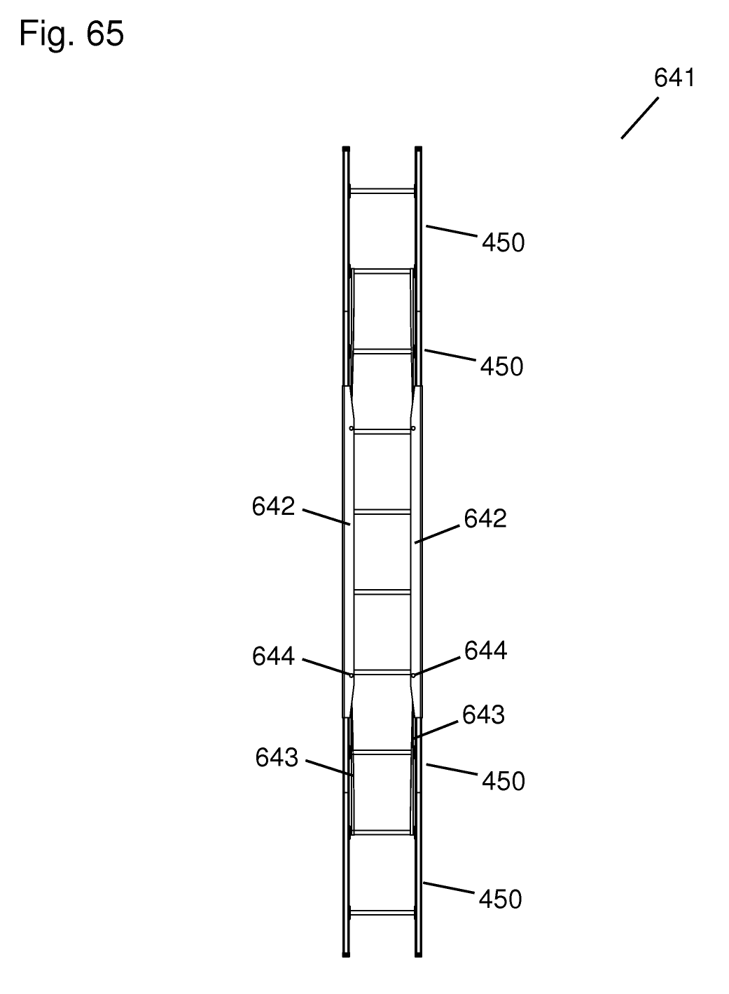

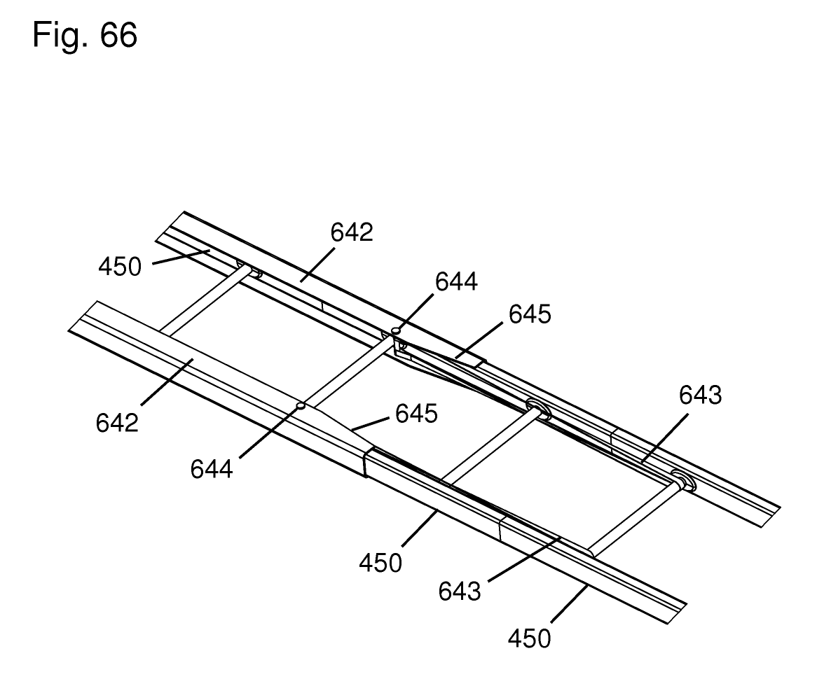

FIGS. 64 through 66 show a segmented bridge 641 including five ladder segments 450 and a bridge conversion kit. The bridge conversion kit preferably includes C-channels 642 placed around the side beams of the ladder segments 450 and held in place by pins 644. In some preferred embodiments, the C-channels 642 are made of carbon fiber. When the bridge undergoes load from an individual walking or running across it, the C-channel reinforcements 642 supplement the strength and stiffness of the ladder side beams only in the middle of the bridge. Although the C-channels 642 could be extended to cover the entire length of the bridge, this is unnecessary, since the maximum stresses are present near the mid-span. Also, to alleviate stress concentrations at the ends of the C-channels 642, angled cuts 645 are preferably made, locally weakening the C-channels 642, thus providing a smoother transition to the non-reinforced side beams. Straps 643 are preferably connected to the pins 644, which ensure that the outer ladder segments 450 do not separate from the other ladder segments when undergoing deflection.

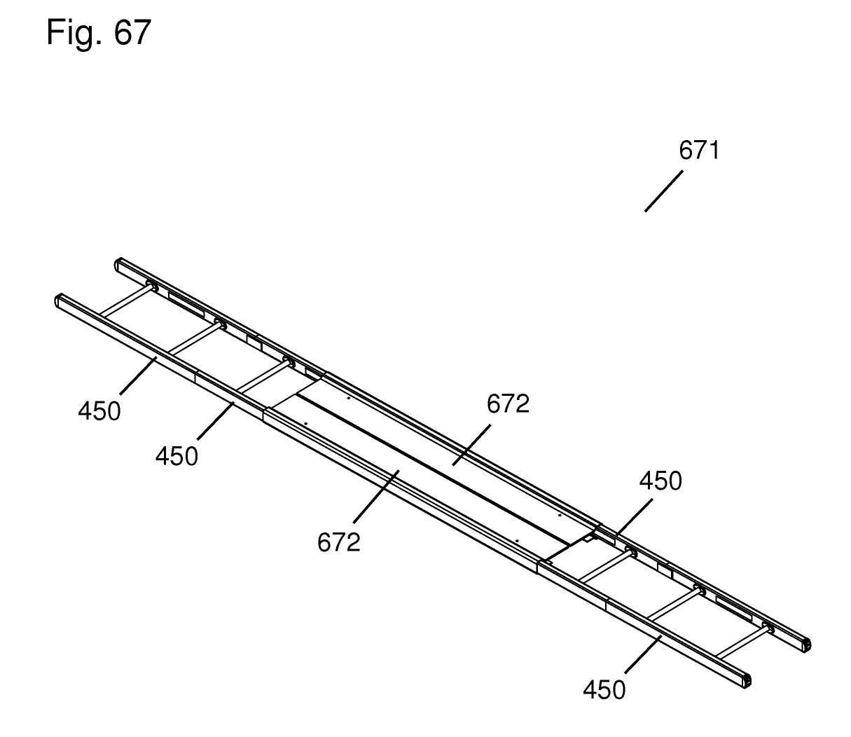

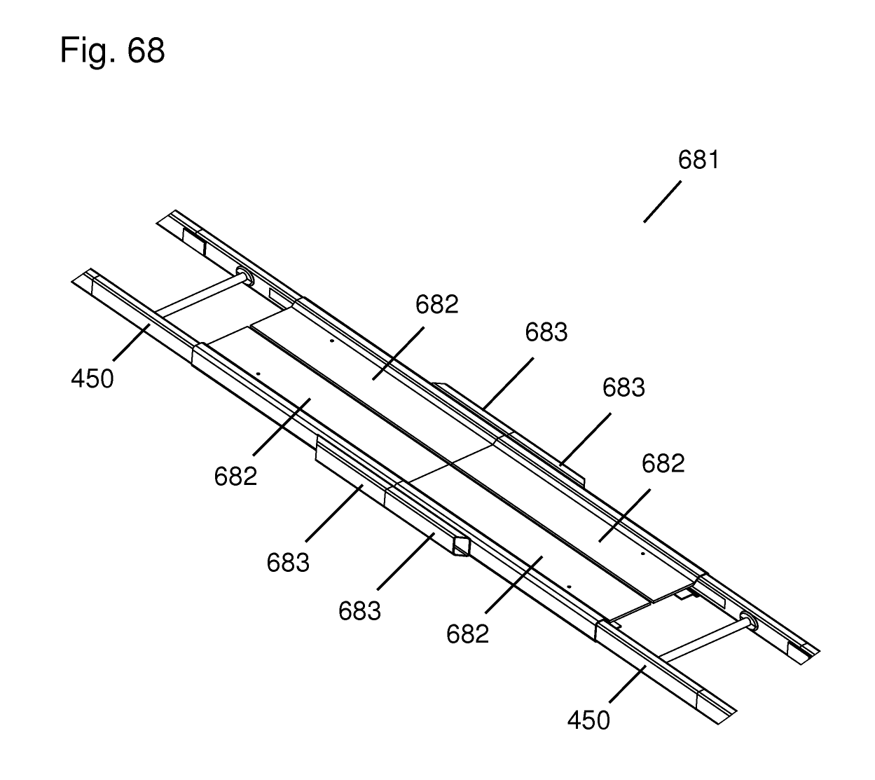

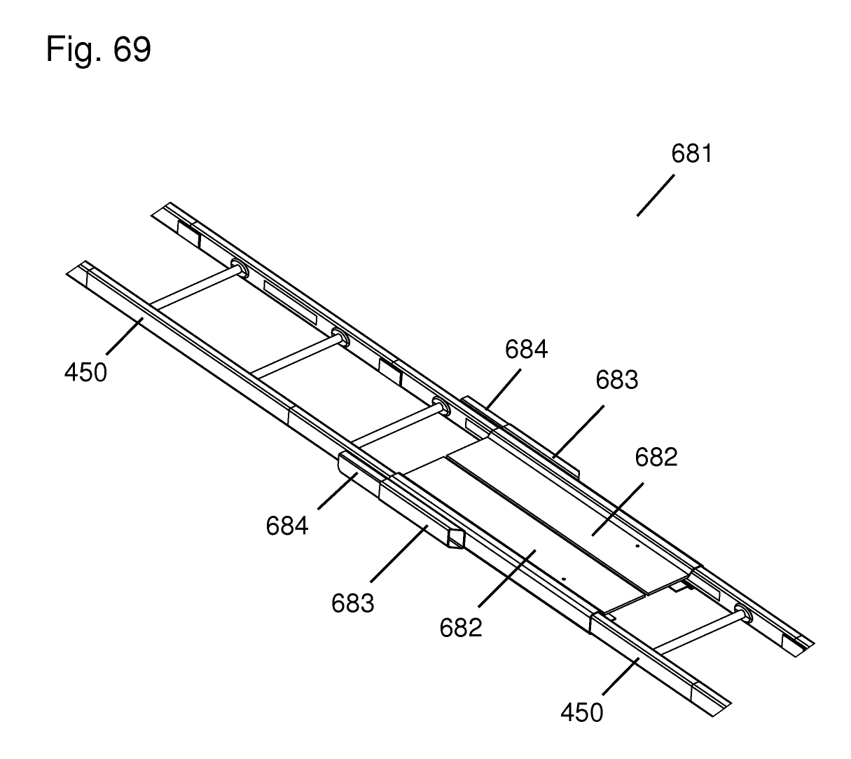

An alternate embodiment of a segmented bridge 671 is shown in FIG. 67. Instead of basic C-channels, the top flange of each C-channel is extended inward to create a deck walking surface 672. In some preferred embodiments, the C-channel, including the deck walking surface 672, is made of carbon fiber. The deck walking surfaces 672 slide over the side rails of the ladder segments 450 to secure them in place. The segmented bridge 671 in FIG. 67 is shown with a 2-piece bridge conversion kit. Alternatively, a 4-piece bridge conversion kit 681 is used, as shown in FIG. 68. This embodiment includes 4 bridge pieces 682 that each slide over the side rails of the ladder segments 450 to properly position them. An extra tube 683 is bonded to the outside surface of each deck section 682, and contains the splice joints 684, as shown in FIG. 69. The splice joints 684 connect the bridge decks 682, strengthening the center of the bridge 681.

In some preferred embodiments of the segmented bridge 641, 671, the carbon fiber side rails or the carbon fiber rungs include an inner carbon fiber layer, an outer carbon fiber layer and a plurality of carbon fiber strips sandwiched between the inner carbon fiber layer and the outer carbon fiber layer. In other preferred embodiments of the segmented bridge 641, 671, the carbon fiber side rails or the carbon fiber rungs include an inner carbon fiber layer, an outer carbon fiber layer, and a layer of uni-directional carbon fiber material surrounding the inner carbon fiber layer. In other preferred embodiments, the carbon fiber side rails or the carbon fiber rungs include an inner carbon fiber layer and an outer carbon fiber layer, where at least one of the inner and outer carbon fiber layers includes a braided carbon fiber material. In some of these embodiments, at least one layer of uni-directional carbon fiber material is placed between the inner carbon fiber layer and the outer carbon fiber layer. In some preferred embodiments, the carbon fiber side rails, the c-channel bridge reinforcements, and/or the carbon fiber rungs are filled with a core material. In embodiments where the c-channel bridge reinforcements 642, 672 are made of carbon fiber, the c-channel bridge reinforcements may also or alternatively have any of the preferred carbon fiber material constructions described in this paragraph.

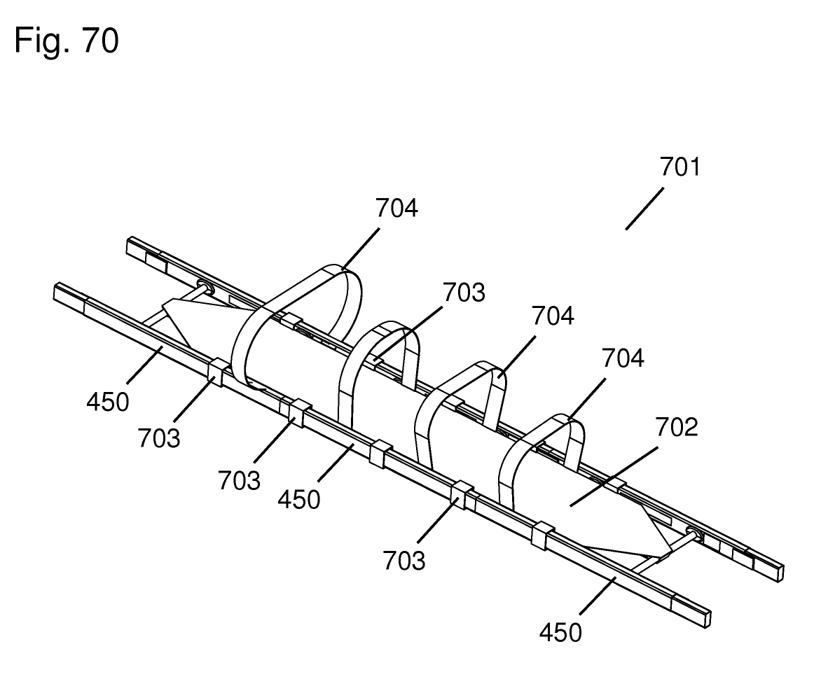

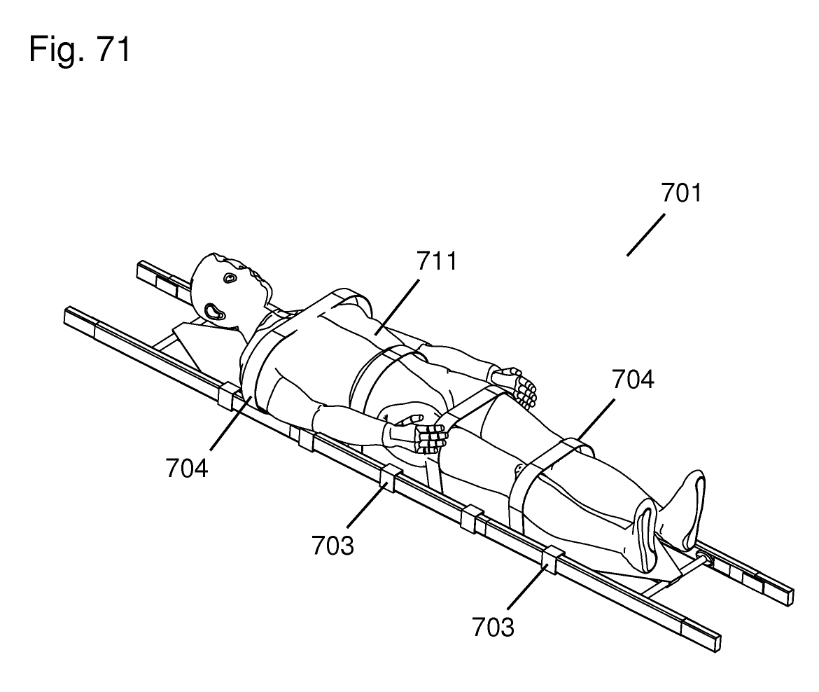

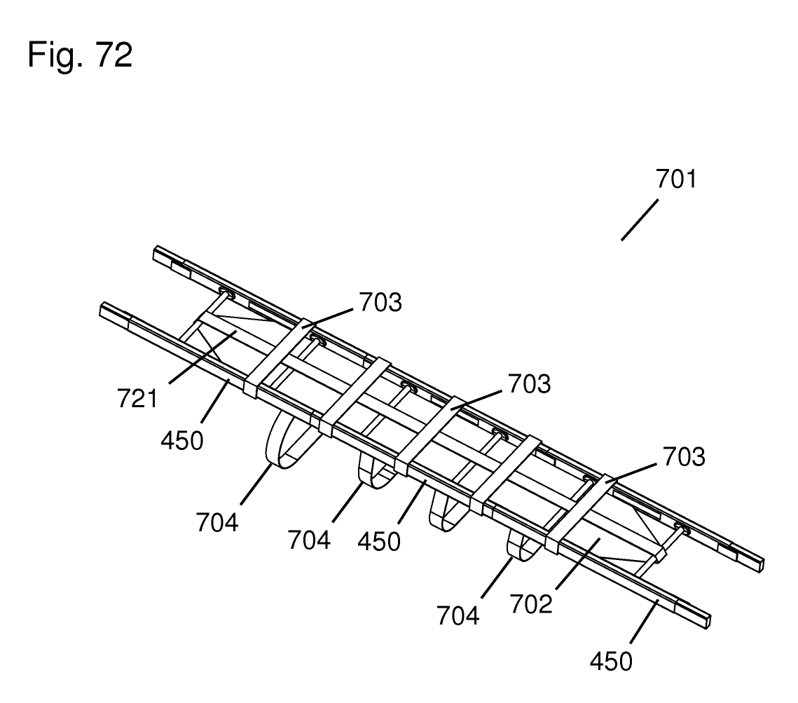

FIGS. 70 through 72 show an embodiment of a segmented emergency stretcher 701. The stretcher 701 preferably includes three ladder segments 450, whereby a stretcher cover 702, preferably made of fabric, is placed over the ladder segments 450 and secured in placed by a longitudinal retention strap 721, shown in FIG. 72, and one or more lateral straps 703. The patient 711 is held securely in place against the stretcher cover 702 using one or more patient support straps 704.

A segmented ladder stretcher system allows the end-user to transform a basic segmented ladder into a stretcher, yet maintains the easy portability of the original ladder design. When the stretcher is not needed, the stretcher cover 702 can be removed, and the ladder used as normal, or alternatively the ladder can be stored in a carry bag.

In some preferred embodiments of the stretcher, the carbon fiber side rails or the carbon fiber rungs include an inner carbon fiber layer, an outer carbon fiber layer and a plurality of carbon fiber strips sandwiched between the inner carbon fiber layer and the outer carbon fiber layer. In other preferred embodiments of the stretcher, the carbon fiber side rails or the carbon fiber rungs include an inner carbon fiber layer, an outer carbon fiber layer, and a layer of uni-directional carbon fiber material surrounding the inner carbon fiber layer. In other preferred embodiments, the carbon fiber side rails or the carbon fiber rungs include an inner carbon fiber layer and an outer carbon fiber layer, where at least one of the inner and outer carbon fiber layers includes a braided carbon fiber material. In some of these embodiments, at least one layer of uni-directional carbon fiber material is placed between the inner carbon fiber layer and the outer carbon fiber layer. In some preferred embodiments, the carbon fiber side rails and/or the carbon fiber rungs are filled with a core material.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A bus assault platform comprising:
a) at least one ladder segment, comprising:
i) a pair of carbon fiber tubes forming a pair of tubular carbon fiber side rails, each carbon fiber side rail having a first side rail end and a second side rail end; and
ii) at least one carbon fiber rung perpendicular to the carbon fiber side rails, wherein the carbon fiber rung connects the carbon fiber side rails of the ladder segment;
b) a deck; and
c) two removable deck connectors;
wherein the removable deck connectors join the carbon fiber side rails to the deck.

2. The bus assault platform of claim 1, wherein:
the deck comprises a horizontal platform having a top surface and a bottom surface and two deck tubes extending down from the bottom surface of the horizontal platform, wherein the two deck tubes each have a first deck tube end and a second deck tube end;
the removable deck connectors each have a first deck connector end and a second deck connector end; and
the first deck connector end connects to the first side rail end and the second deck connector end connects to the first deck tube end.

3. The bus assault platform of claim 2, further comprising a pair of feet connected to the second deck tube ends.

4. The bus assault platform of claim 2, wherein the deck is made of carbon fiber.

5. The bus assault platform of claim 1, wherein the deck connectors are made of carbon fiber.

6. The bus assault platform of claim 1, wherein the carbon fiber side rails or the carbon fiber rung comprises:
a) an inner carbon fiber layer;
b) an outer carbon fiber layer; and
c) a plurality of carbon fiber strips sandwiched between the inner carbon fiber layer and the outer carbon fiber layer.

7. The bus assault platform of claim 1, wherein the carbon fiber side rails or the carbon fiber rung comprises:
a) an inner carbon fiber layer;
b) an outer carbon fiber layer; and
c) a layer of uni-directional carbon fiber material surrounding the inner carbon fiber layer.

8. The bus assault platform of claim 1, wherein the carbon fiber side rails or the carbon fiber rung comprises:
a) an inner carbon fiber layer; and
b) an outer carbon fiber layer; and
wherein at least one of the inner and outer carbon fiber layers comprises a braided carbon fiber material.

9. The bus assault platform of claim 8, further comprising at least one layer of uni-directional carbon fiber material placed between the inner carbon fiber layer and the outer carbon fiber layer.

10. The bus assault platform of claim 1, wherein at least one of the carbon fiber side rails, the removable deck connectors, and the carbon fiber rung is filled with a core material.

11. The bus assault platform of claim 1, wherein a portion of the rung is located inside each of the carbon fiber side rails and is bonded to an interior of each carbon fiber side rail.

12. The bus assault platform of claim 1, further comprising a flange on each side of the rung that matches a contour of the rung.

13. The bus assault platform of claim 1, further comprising a pair of feet, wherein the feet are located on a bottom side rail end of the pair of carbon fiber side rails such that the feet provide friction for the structure when the feet are placed on the ground.

14. A modular bridge system comprising:
a) at least two ladder segments, wherein each ladder segment comprises:
i) a pair of carbon fiber tubes forming a pair of tubular carbon fiber side rails, each carbon fiber side rail having a first side rail end and a second side rail end; and
ii) at least one carbon fiber rung perpendicular to the carbon fiber side rails, wherein the carbon fiber rung connects the carbon fiber side rails of the ladder segment;
b) at least one joint connector located at at least one of the first end and the second end of each carbon fiber side rail; and
c) at least one c-channel bridge reinforcement placed around the side rails and spanning a length of the joint connector;
wherein the joint connector on an end of the first carbon fiber side rail of a first ladder segment is shaped to fit inside the carbon fiber side rail of an adjoining ladder segment or mates with the joint connector on the second carbon fiber side rail of a second ladder segment.

15. The modular bridge system of claim 14, wherein the c-channel bridge reinforcement is made of carbon fiber.

16. The modular bridge system of claim 14, wherein the c-channel bridge reinforcement comprises at least one flange that extends across the rungs to create a walking surface.

17. The modular bridge system of claim 14, further comprising at least one pin and at least one strap to fasten the c-channel bridge reinforcement to the ladder segments.

18. The modular bridge system of claim 14, wherein the carbon fiber side rails or the carbon fiber rung comprises:
a) an inner carbon fiber layer;
b) an outer carbon fiber layer; and
c) a plurality of carbon fiber strips sandwiched between the inner carbon fiber layer and the outer carbon fiber layer.

19. The modular bridge system of claim 14, wherein the carbon fiber side rails or the carbon fiber rung comprises:
a) an inner carbon fiber layer;
b) an outer carbon fiber layer; and
c) a layer of uni-directional carbon fiber material surrounding the inner carbon fiber layer.

20. The modular bridge system of claim 14, wherein the carbon fiber side rails or the carbon fiber rung comprises:
a) an inner carbon fiber layer; and
b) an outer carbon fiber layer; and
wherein at least one of the inner and outer carbon fiber layers comprises a braided carbon fiber material.

21. The modular bridge system of claim 20, further comprising at least one layer of uni-directional carbon fiber material placed between the inner carbon fiber layer and the outer carbon fiber layer.

22. The modular bridge system of claim 14, wherein at least one of the carbon fiber side rails, the c-channel bridge reinforcements, and the carbon fiber rung is filled with a core material.

23. The modular bridge system of claim 14, wherein a portion of the rung is located inside each of the carbon fiber side rails and is bonded to an interior of each carbon fiber side rail.

24. The modular bridge system of claim 14, further comprising a flange on each side of the rung that matches a contour of the rung.

25. The modular bridge system of claim 14, wherein each c-channel bridge reinforcement comprises:
a) a first c-channel bridge reinforcement member;
b) a second c-channel bridge reinforcement member;
c) a first carbon fiber tube attached to a surface of the first c-channel bridge reinforcement member;
d) a second carbon fiber tube attached to a surface of the second c-channel bridge reinforcement member; and
e) a splice joint permanently bonded inside the first carbon fiber tube and sized to fit inside the second carbon fiber tube.

26. A modular stretcher comprising:
a) at least two ladder segments, wherein each ladder segment comprises:
i) a pair of carbon fiber tubes forming a pair of tubular carbon fiber side rails, each carbon fiber side rail having a first side rail end and a second side rail end; and
ii) at least one carbon fiber rung perpendicular to the carbon fiber side rails, wherein the carbon fiber rung connects the carbon fiber side rails of the ladder segment;
b) a joint connector located at at least one of the first end and the second end of each carbon fiber side rail; and
c) a stretcher cover;
wherein the joint connector on an end of the first carbon fiber side rail of a first ladder segment is shaped to fit inside the carbon fiber side rail of an adjoining ladder segment or mates with the joint connector on the second carbon fiber side rail of a second ladder segment; and
wherein the stretcher cover is secured to the ladder segments.

27. The modular stretcher of claim 26, wherein the stretcher is secured to the ladder segments using a plurality of straps or rope.

28. The modular stretcher of claim 26, further comprising a plurality of straps for securing a person to the modular stretcher.
